(19) United States
(12) Patent Application Publication
(10) Pub. No.: US 2015/0178725 A1
(43) Pub. Date: Jun. 25, 2015

(54) TRANSACTION AUTHORIZATION CONTROL AND ACCOUNT LINKING INVOLVING MULTIPLE AND SINGULAR ACCOUNTS OR USERS

(71) Applicant: Nicholas Poetsch, Scottsdale, AZ (US)

(72) Inventor: Nicholas Poetsch, Scottsdale, AZ (US)

(21) Appl. No.: 14/139,393

(22) Filed: Dec. 23, 2013

(51) Int. Cl. G06Q 20/40

(52) U.S. Cl. CPC G06Q 20/40

(57) ABSTRACT

Systems and methods for controlling authorized transactions associated with an account and for linking multiple accounts are disclosed. The systems and methods may be implemented over a network and may include receiving input from an account holder and/or account user, each of which may communicate with the system through a user interface displayed on a computing device such as a computer, laptop, tablet, or smartphone. The system may allow one or more account holders to restrict the scope of permissible transactions associated with an account by updating transaction restriction parameters stored in memory. The system may further allow one or more accounts to be linked according to one or more link parameters. Where an account is associated with multiple authorized account holders, the system may facilitate a negotiation process through which the multiple holders concur on changes to transaction restriction parameters and/or link parameters before the system implements the same.

### BACKGROUND

Card transactions are a dominant form of payment used in various types of point-of-sale situations. During a typical transaction, an account holder will select goods or services and pay using a singular debit, check, or credit card account. Before releasing the goods or, on completion of a service, merchants use existing transaction processing systems to send an authorization request to a payment service provider such as CyberSource Corporation of San Francisco, Calif. The payment service provider then relays the authorization request to the account holder's financial institution for further processing. The authorization request may contain information about the account holder, account number, type of item being purchased, and the like. Often times, the payment service provider communicates with the financial institution's servers in which the account holder's account information is stored. The server compares the balance of the account to the transaction being requested. The account information is updated automatically whenever credits and debits are made to the account. The transaction will then either be approved or denied and the decision is sent to the merchant. The merchant then releases the goods having received assurance that their account will be credited in accordance with the transaction.

Although financial institutions limit an account holder's ability to execute transactions based on account balance and credit limit, such limits are restrictive only in the sense that the financial institution will not approve a transaction that is associated with an account containing insufficient funds or credit. Present systems offer little or no additional functionality through which an account holder can self-define his or her own restrictions. There is a need for systems and methods offering greater account control and security, such as those permitting an account holder to self-configure the criteria by which a requested transaction is evaluated and either approved or denied.

Moreover, existing systems do not allow account users to easily pay for goods or services by splitting the cost between multiple accounts. On the contrary, an authorized account holder on wishing to pay using funds or credit from multiple accounts must laboriously consolidate funds or credit from the multiple accounts into a single account prior to attempting the purchase. Having to do so is inconvenient, time consuming, and can present problems related to tracking funds or credit where numerous account holders and account users are involved in a single process. As such, there is a need for systems and methods for linking multiple accounts in a controlled, configurable manner.

### SUMMARY

Systems and methods for transaction authorization control and account linking involving multiple and singular accounts or users are disclosed. A method for controlling transactions associated with an account having one or more account holders may include steps of receiving a request from a first account holder to access an account and executing instructions stored in memory. Execution of the instructions by a processor of a computing device may cause the computing device to grant the first account holder access to the account and receive from the first account holder a request to update a transaction restriction parameter stored in memory. The transaction restriction parameter may be associated with the account and may control or restrict the ability of an account user to use the account for transactions. In response to receiving a request from one or more account holders, execution of the instructions by the processor may further store a new or updated transaction restriction parameter in memory, thereby adjusting the scope of authorized transactions associated with the account.

Moreover, the method may further include receiving a transaction request from a server. The transaction request may include a plurality of transaction details. The method may further include executing instructions stored in memory, wherein execution of the instructions by the processor causes the computing device to compare the transaction details to the new or updated transaction restriction parameter. Execution of the instructions by the processor may further approve the transaction request when the transaction details do not violate the new or updated transaction restriction parameter and may decline the transaction request when the transaction details violate the new or updated transaction restriction parameter. The method may enable multiple account holders to negotiate an agreed upon transaction restriction parameter update using one or more counter-proposed updates.

The method may be implemented by a transaction authorization control system. The transaction control system may include a network and a server communicatively coupled by the network to a computing device associated with a first account holder. The server may include a processor and executable instructions stored in memory. Execution of the instructions by the processor may cause the system perform some or all of an embodiment of the above-described method for controlling transactions.

A method for linking multiple accounts may include receiving a request from a first account holder to access a first account. The method may further include executing instructions stored in memory of a computing device. Execution of the instructions by a processor of the computing device may cause the computing device to grant the first account holder access to the first account. The computing device may further receive from the first account holder a request to create an account link with a second account holder associated with a second account. The computing device may further create an account link between the first account associated with the first account holder and the second account associated with the second account holder. In an embodiment, receiving from the first account holder the request to create an account link with the second account holder associated with the second account further may include receiving a request to store a new or updated link parameter in memory. Among many other potential uses, the new or updated link parameter may govern the manner in which credit or funds are to be used from the first and second accounts in response to approving a transaction request.

The method may be implemented by an account linking system. The account linking system may include a server communicatively coupled by the network to a computing device associated with a first account holder. The server may include a processor and executable instructions stored in memory. Execution of the instructions by the processor may cause the server to perform some or all of an embodiment of the above-described method for linking multiple accounts.

### BRIEF DESCRIPTION OF THE DRAWINGS

FIG. 1 is a block diagram illustrating an exemplary transaction authorization control system.

FIG. 2 is a block diagram illustrating the operation of an exemplary transaction authorization control system.

FIG. 3 illustrates an exemplary graphical user interface that may displayed on an account holder computing device and used to interact with various functionalities of the system disclosed herein.

FIG. 4 illustrates another exemplary graphical user interface that may displayed on an account holder computing device and used to interact with various functionalities of the system disclosed herein.

FIG. 5 illustrates another exemplary graphical user interface that may displayed on an account holder computing device and used to interact with various functionalities of the system disclosed herein.

FIG. 6 illustrates another exemplary graphical user interface that may displayed on an account holder computing device and used to interact with various functionalities of the system disclosed herein.

FIG. 7 illustrates another exemplary graphical user interface that may displayed on an account holder computing device and used to interact with various functionalities of the system disclosed herein.

FIG. 8 illustrates another exemplary graphical user interface that may displayed on an account holder computing device and used to interact with various functionalities of the system disclosed herein.

FIG. 9 illustrates another exemplary graphical user interface that may displayed on an account holder computing device and used to interact with various functionalities of the system disclosed herein.

FIG. 10 illustrates another exemplary graphical user interface that may displayed on an account holder computing device and used to interact with various functionalities of the system disclosed herein.

FIG. 11 illustrates another exemplary graphical user interface that may displayed on an account holder computing device and used to interact with various functionalities of the system disclosed herein.

FIG. 12 illustrates another exemplary graphical user interface that may displayed on an account holder computing device and used to interact with various functionalities of the system disclosed herein.

FIG. 13 illustrates another exemplary graphical user interface that may displayed on an account holder computing device and used to interact with various functionalities of the system disclosed herein.

FIG. 14 illustrates another exemplary graphical user interface that may displayed on an account holder computing device and used to interact with various functionalities of the system disclosed herein.

FIG. 15 illustrates another exemplary graphical user interface that may displayed on an account holder computing device and used to interact with various functionalities of the system disclosed herein.

FIG. 16 is a block diagram illustrating the operation of an exemplary transaction authorization control system.

FIG. 17 is a block diagram further illustrating the operation of an exemplary account linking system.

FIG. 18 illustrates another exemplary graphical user interface that may displayed on an account holder computing device and used to interact with various functionalities of the system disclosed herein.

FIG. 19 illustrates another exemplary graphical user interface that may displayed on an account holder computing device and used to interact with various functionalities of the system disclosed herein.

FIG. 20 illustrates another exemplary graphical user interface that may displayed on an account holder computing device and used to interact with various functionalities of the system disclosed herein.

FIG. 21 illustrates another exemplary graphical user interface that may displayed on an account holder computing device and used to interact with various functionalities of the system disclosed herein.

FIG. 22A illustrates another exemplary graphical user interface that may displayed on an account holder computing device and used to interact with various functionalities of the system disclosed herein.

FIG. 22B illustrates another exemplary graphical user interface that may displayed on an account holder computing device and used to interact with various functionalities of the system disclosed herein.

FIG. 23 illustrates another exemplary graphical user interface that may displayed on an account holder computing device and used to interact with various functionalities of the system disclosed herein.

FIG. 24 illustrates another exemplary graphical user interface that may displayed on an account holder computing device and used to interact with various functionalities of the system disclosed herein.

FIG. 25 is another block diagram further illustrating the operation of an exemplary account linking system.

FIG. 26 is a block diagram of an exemplary computing device for implementing various embodiments of the systems and methods disclosed herein.

### DETAILED DESCRIPTION

Various embodiments of systems and methods for transaction authorization control and account linking involving multiple and singular accounts or users are disclosed. Such systems and methods may offer single account holders enhanced flexibility when paying for goods or services or when establishing a long-term method of providing for the financial needs of an authorized account user. The system and methods may be implemented over a network and may include input from an account holder and an account user, each of which may communicate with or be integrated within the system by a graphical user interface displayed on a computing device such as a computer, laptop, tablet, or smartphone.

The system may perform a method for controlling transactions associated with an account having multiple authorized account holders. The system may allow one or more account holders to restrict the scope of permissible transactions associated with an account by creating and updating various transaction restriction parameters that may later be compared to a requested transaction. The system may further allow one or more accounts to be linked according to one or more link parameters stored in memory of the system. Where an account is associated with multiple authorized account holders, the system may facilitate a real-time negotiation process through which the multiple holders debate and in some cases eventually concur on changes to transaction restriction parameters and/or link parameters before the system implements the same.

Persons of ordinary skill in the art will readily recognize that the following description is illustrative only. Throughout the description, references are made to various exemplary parameters that an account holder and/or account user may configure to customize an account to better suit his or her needs. Some embodiments of the systems and methods may include various parameters and sub-parameters governing an account or a relationship between multiple accounts. Such exemplary parameters and sub-parameters have been presented in order to most clearly describe the fundamental and novel concept underlying the disclosed system and methods. For example, various sections of the present disclosure discuss “transaction restriction parameters,” while other sections discuss “link parameters.” Any discussion of such parameters should not be viewed as exhaustive or limited. Persons of ordinary skill in the art will readily recognize that the system and methods disclosed herein are readily applicable to many other types of configurable parameters. Moreover, such persons will readily recognize that any functionality described herein with reference to one type of parameter may be utilized with respect to a number of other types of parameters. Persons of ordinary skill in the art will further understand that any reference to parameter being “created,” “stored,” or “updated” may interchangeably refer to the a parameter that has been newly created for the first time or updated from a previous state or value.

### Transaction Authorization Control

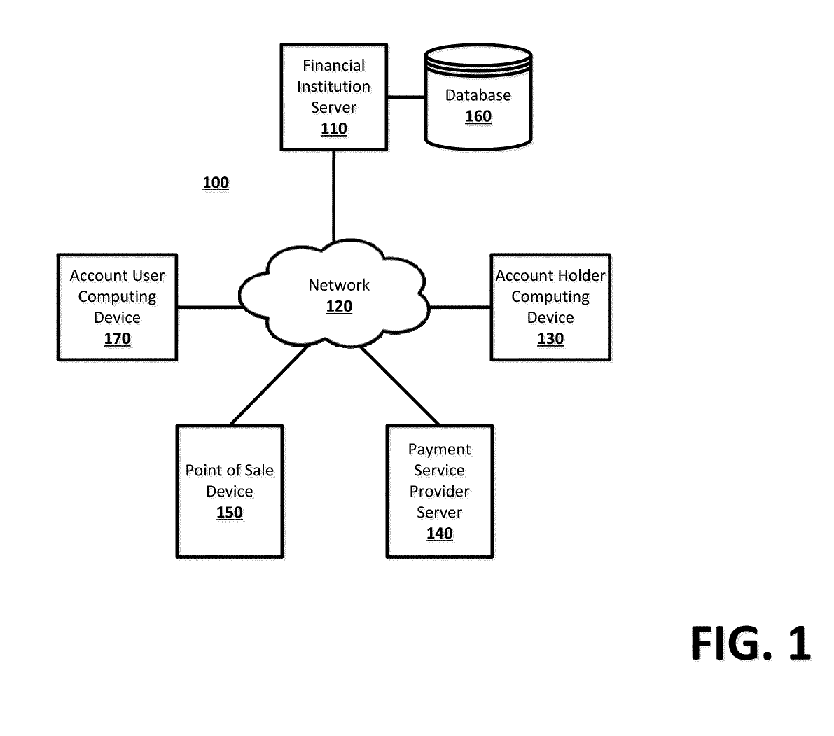

FIG. 1 illustrates an exemplary transaction authorization control system in accordance with the present disclosure. According to one illustrative embodiment, a transaction authorization control system 100 may include a server 110 communicatively coupled by a network 120 to a computing device 130 associated with a first account holder. Server 110 may be a financial institution server as labeled in FIG. 1, or it may be a payment service provider server or other third-party server. In some embodiments, system 100 may include a payment service provider server 140 in addition to server 110. Although not shown in FIG. 1, server 110 may include a processor and executable instructions stored in memory. System 100 may further include or interact with a point of sale device 150, such as a point of sale terminal or a server hosting a webpage that receives payment information. For illustrative purposes, payment service provider 140 and point of sale device 150 have been included in FIG. 1. However, system 100 may or may not incorporate such devices depending on the needs of the system administrator and/or the end-users.

System 100 may perform a method for controlling transactions executed by an account having multiple authorized account holders. Server 110 may receive a request from the first account holder to access an account associated with the first account holder. The request for access may include a variety of login credentials, including a user name, password, security question, or any number of other login credentials that are known in the art and readily recognizable by persons of ordinary skill in the art.

Upon receiving the request from the first account holder, execution of the instructions by the processor may cause server 110 to grant the first account holder access to the account based on the login credentials. Server 110 may grant access to the first account holder using any number of well-known login credential verification processes known in the art. In an effort to keep the present disclosure focused and concise, a detailed discussion of the many suitable login verification processes has been omitted. Persons of ordinary skill in the art will readily appreciate such processes and their applicability to the systems and methods disclosed herein.

Server 110 may include a database 160. In some embodiments, database 160 may be stored in memory of server 110, while in other embodiments database 160 may be maintained in one or more separate servers communicatively coupled to server 110 by network 120. Database 160 may store one or more transaction restriction parameters associated with the account belonging to the first account holder.

As discussed further below, the transaction restriction parameters may include a variety of configurable parameters that server 110 analyzes to determine the scope of permissible transactions executable using funds maintained in the account. In other words, the transaction restriction parameters are associated with the account and effectively restrict the ability of an account user to use the account for transactions. Using transaction restriction parameters, server 110 may effectively serve as a firewall for certain transactions that an account user might attempt to execute. Normal transactions that would otherwise have been approved may be denied according to the wishes of one or more authorized account holders associated with the account. Such a system provides greater flexibility in controlling what sort of transactions may be completed using a particular account. In some cases, an account holder may wish to restrict his or her own spending habits in order to remain within a particular budget or to refrain from making particular purchases altogether. In other cases, an account holder may wish to restrict transactions associated with an account because he or she wants someone else—such as an authorized user associated with the account—to stay on budget or refrain from making particular purchases.

The transaction restriction parameters may be stored in one or more tables associated with the account. The tables may be stored in previously described database 160, or they may be stored in any other suitable data structure, several of which will be readily apparent to persons of ordinary skill in the art.

The transaction restriction parameters may be based on existing data that merchants and service providers generate and often supply to financial institutions during the course of a transaction. For example, the transaction restriction parameters may be based on codes known in the art, such as universal product codes (UPCs), international article numbers (EANs), and the like. By recognizing such codes, system 100 may allow an account holder to create and modify transaction restriction parameters so that the account holder can set exactly what types of transactions will be denied or authorized when an account user—which may even be the account holder itself—attempts to execute a transaction.

Exemplary categorical transaction restriction parameters such as those listed below may be configured using system 100:

### Transaction Amount

Daily limit on collective transaction total
Transactions below or above a threshold specified
Number of transactions
Funds shared between accounts (which may or may not be used with account linking)
Fixed percentage to pay per transaction (as opposed to authorizing full payment)

### Transaction Type

Cash advances
Split payments
Single payments vs. recurring payments
One-time transactions

### Special

Types of merchants (i.e., gas stations, restaurants, etc.)
Authorized users
Transactions between, to, and/or from certain companies
Type of item purchased (i.e., gas, food, books, tuition)
Transactions during given times (i.e., only allow between 8:00 AM and 8:00 PM)
Offline vs. online transactions (allowing only one or the other or both)
Transactions only from/on a particular IP address
Transactions only from/on a particular device (such as a laptop with a particular MAC address or a smartphone associated with a particular identifier)
Approval required before transaction processes
Account expiration
Transactions based on location and/or geography (i.e., only in the U.S.)
Transactions made after account is transferred to secondary account holder(s)

In some embodiments, multiple transaction restriction parameters may be used jointly. Account holders may use the transaction restriction parameters to enlarge or narrow an account user's scope of permissible transactions as much as desired. For example, by setting the transaction restriction parameters, an account holder may cause system 100 to allow a transaction only when the transaction request is received from a given device at certain times throughout the day. Or, for example, system 100 may allow an account holder to completely block all requested transactions during a specified time window. The various transaction restriction parameters described herein are merely exemplary and serve to illustrate the spirit of the technology disclosed herein. The above list should not be viewed as exhaustive and is in no way intended to limit the scope of the claims.

Server 110 may receive from the first account holder a request to store a new or updated transaction restriction parameter in memory. In response, server 110 may store the new or updated transaction restriction parameter in memory in accordance with the request. For purposes of this disclosure, the phrases “request to store a new or updated transaction restriction parameter” and “update request” may be used interchangeably. In other words, the term “update request” is not limited to requesting that an existing transaction restriction parameter be updated—it may also include a request to create a brand new transaction restriction parameter. Any reference to “storing a new or updated transaction restriction parameter” or “updating a transaction restriction parameter” are likewise interchangeably and not intended to be limited to the act of updating existing parameters. The same applies to any description herein relating to account linking or link parameters.

In some embodiments, updating the transaction restriction parameter may include two sub-steps wherein the server first confirms that the account is not associated with a second account holder before updating the transaction restriction parameter based on the update request received from the first account holder.

In some situations, an account may be associated with more than one authorized account holder. For example, where a husband and wife share a joint checking or credit account, both parties may have access to the account. In some embodiments, system 100 may require that all authorized account holders concur in any update to a transaction restriction parameter requested by any individual account holder. In such embodiments, updating the transaction restriction parameter may include other sub-steps, including determining that the account is associated with a second account holder. Upon determining that the account is associated with a second account holder, server 110 may send to the second account holder a request to approve the update request received from the first account holder. Server 110 may further receive from the second account holder a response to the approval request. Server 110 may then update the transaction restriction parameter based on the update request received from the first account holder when the response to the approval request received from the second account holder is an approval.

System 100 may further enable multiple account holders to negotiate an agreed upon transaction restriction parameter update using one or more counter-proposed updates. Such functionality may be particularly useful in situations in which multiple account holders may not possess the same financial philosophies or goals. In such embodiments, updating the transaction restriction parameter may include determining that the account is associated with a second account holder and sending to the second account holder a request to approve the update request received from the first account holder. In response to the approval request sent to the second account holder, server 110 may receive from the second account holder a response to the approval request. In some embodiments, the response received from the second account holder may be a counter-proposed update. In such embodiments, upon receiving from the second account holder a counter-proposed update, server 110 may send to the first account holder a request to accept the counter-proposed update received from the second account holder. Server 110 may further receive from the first account holder a response to the acceptance request. Server 110 may update the transaction restriction parameter based on the counter-proposed update received from the second account holder when the response received from the first account holder to the acceptance request is an acceptance.

In some embodiments, system 100 may allow even further negotiations between the first and second account holders. For example, rather than an acceptance, the response from the first account holder to the acceptance request may be a further counter-proposed update. In such cases, server 110 may receive the counter-proposed update from the first account holder and send to the second account holder a request to accept the further counter-proposed update received from the first account holder. Server 110 may further receive from the second account holder a response to the request to accept the further counter-proposed update. Server 110 may then update the transaction restriction parameter based on the further counter-proposed update received from the first account holder when the response received from the second account holder to the request to accept the further counter-proposed update is an acceptance.

In some instances, the multiple account holders may not be able to negotiate an agreed upon update to the transaction restriction parameter at issue. For example, in the aforementioned scenario, rather than accepting the counter-proposed update proposed by the first account holder, the second account holder may simply wish to end the negotiations by flatly denying the request. In such instances, server 110 may send to the first account holder a notification that the second account holder denied the approval request when the response to the approval request received from the second account holder by server 110 is a denial. Server 110 may then deny the update request received from the first account holder, at which point the first account may begin the process over again by proposing a new update to a transaction restriction parameter, which may be same transaction restriction parameter negotiated over previously or some other transaction restriction parameter that the first account holder believes may be better received by the second account holder.

Once a transaction restriction parameter is updated, system 100 may use the transaction restriction parameter when processing a requested transaction. Server 110 may receive a transaction request. The transaction request may include a plurality of transaction details. The transaction request may have been sent by a merchant server, a payment service provider server, or some other third-party intermediary server. In response to receiving the transaction request, server 110 may execute instructions stored in memory. In some embodiments, execution of the instructions by the processor of server 110 may cause server 110 to compare the transaction details to the updated transaction restriction parameter. Server 110 may approve the transaction request when the transaction details do not conflict with or otherwise violate the updated transaction restriction parameter. Conversely, server 110 may decline the transaction request when the transaction details conflict with or otherwise violate the updated transaction restriction parameter.

In some embodiments, when a transaction is declined because it violates a transaction restriction parameter, server 110 may notify the account holder associated with the account. In such embodiments, server 110 may notify the account holder that the transaction request was denied for violating the updated transaction restriction parameter. Where an account is associated with multiple account holders, server 110 may notify all account holders. In some embodiments, server 110 may notify less than all account holders to avoid notifying account holders who do not wish to receive notifications from system 100. For example, where a father is the account holder and his son is the account user, the father may not wish to receive a denial notification every time the son attempts to purchase something that the son is not permitted to buy using the account managed by system 100.

In one embodiment, server 110 may automatically suggest to the account holder an update to the transaction restriction parameter that would permit approval of the transaction request. In some instances, an account user may be making a good faith attempt to execute a transaction within the scope of permissible transactions, but yet may accidentally violate a transaction restriction parameter. For example, in a scenario wherein a transaction restriction parameter limits the account user to transactions under $50.00 dollars when the item purchased is food, an account user could accidentally bring $51.13 worth of groceries to the cashier because the account user miscalculated the sales tax. In such cases, upon attempting to pay for the goods, some illustrative embodiments of server 110 may decline the transaction for violating the transaction restriction parameter limiting the account user to transactions under $50.00 when the item purchased is food. In some such embodiments, server 110 may then notify the account holder that system 100 declined an attempted $51.13 transaction for food-related goods, but would permit the transaction subject to the account holder approving a suggested update to the transaction restriction parameter. For example, the suggested update to the transaction restriction parameter may be to increase the maximum transaction value from $50.00 to $51.13.

In some embodiments, the suggested update to the transaction restriction parameter may be a one-time update that reverts back to the previous transaction restriction parameter immediately following completion of the transaction. In such cases, the update may effectively serve as a “one-time exception” to the general transaction restriction parameter. In other embodiments, the suggested update to the transaction restriction parameter may be permanent subject to the account holder manually resetting the transaction restriction parameter using the systems and methods described herein. In still further embodiments, system 100 may provide the account holder with the option of approving the suggested update as a one-time exception or as the new general transaction restriction parameter moving forward.

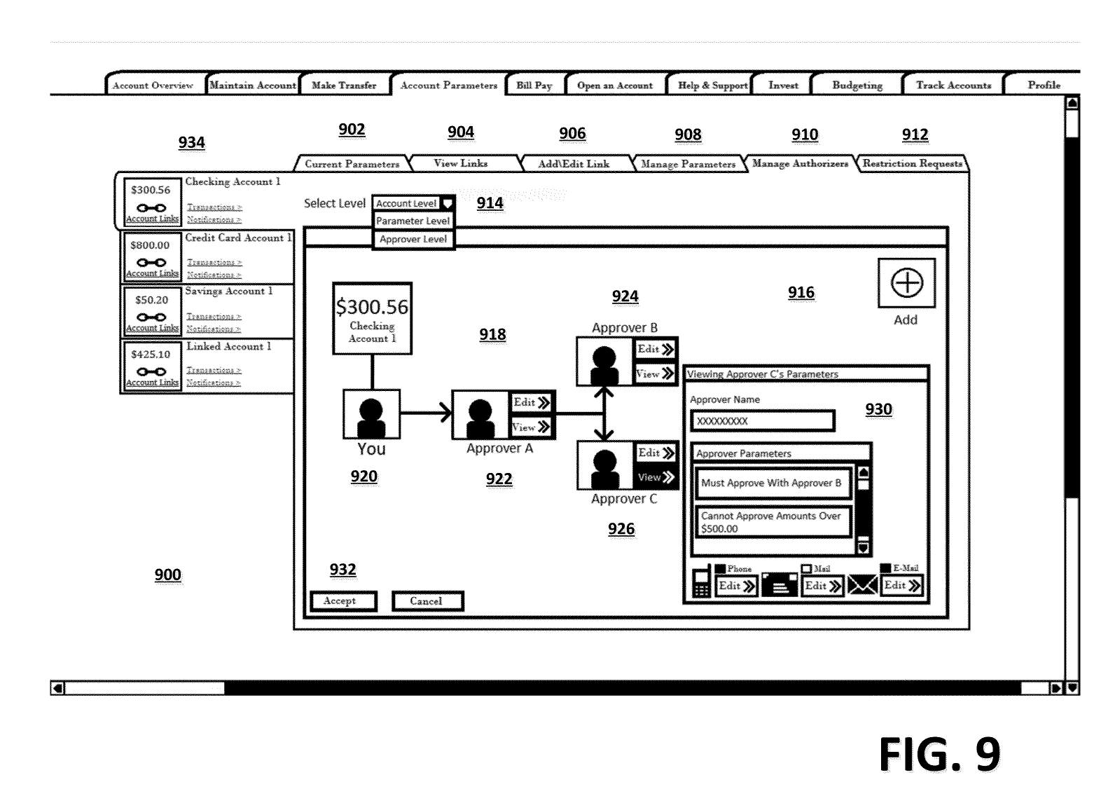

In some embodiments, the system may also receive from an account holder information sufficient to identify a third-party whom the account holder trusts and wishes to have the authority to accept or deny update requests on the account holder's behalf. Such information may be received through input fields or configurable tools displayed on a graphical user interface of the account holder computing device. One exemplary graphical user interface is shown and later described at FIG. 9. In such embodiments, any description herein relating to system functionality exercisable through an account holder computing device may apply equally to an authorized third-party reviewer device. For instance, in one conceivable scenario, an account holder may be a busy politician. The politician may have established an account managed by system 100 for the benefit of her niece. The politician may want the ability to manage the account in part—such as by configuring transaction restriction parameters—but she may be too busy to review and approve update requests that are sent by the niece to the system and subsequently relayed to the politician's computing device (e.g., her smartphone). Accordingly, the politician may wish to appoint a family member or trusted staff member to receive the update requests either in addition to or in lieu of the politician receiving them. In a similar conceivable scenario, a chief executive officer may be an authorized account holder on behalf of his corporation. Various employees of the corporation may be authorized account users. The chief executive officer may wish to delegate review and approval authority of any update requests to his chief financial officer. In light of the foregoing, it should be readily understood by persons of ordinary skill in the art that any of the functionalities described herein with request to authorized account holders may apply equally to third-party reviewers identified by such account holders.

In some embodiments, some or all of the transaction restriction parameters associated with an account may be conditional. Namely, system 100 may receive from an account holder an advanced request to store a new or updated transaction restriction parameter subject to a particular event occurring at a later date. In doing so, system 100 may allow account holders to plan ahead for certain life altering events that like death or disability.

For example, in one embodiment, system 100 may provide an account holder with tools for configuring a “service type” transaction restriction parameter. The account holder may wish the default service type restriction parameter to be so broad that any and all services may be purchased using the account. However, the account holder may wish to plan ahead such that in the event of a disability, the service type restriction parameter is updated such that only medical-related services may be purchased using that same account. Combining conditional parameter functionality may be particularly useful in combination with the above-described functionality relating to third-party approvers. For instance, where the account holder identifies a third-party approver in advance, the third-party approver may take over administering the account on behalf of the account holder. The third-party approve may notify system 100 of the account holder's disabling event. In response, system 100 may automatically trigger any conditional parameters that the account holder requested in advance prior to the disabling event. Alternatively, system 100 may receive a disability indication from some third-party source, such as a medical service provider. Upon receiving the indication, system 100 may automatically store the conditional parameters that were requested in advance.

Similarly, system 100 may be useful for planning ahead in the event of death. System 100 may receive conditional parameters in advance from an account holder that may be activated at a later date to adjust the spending power of one or more authorized users associated with the account. For instance, while alive, an account holder may wish his or her child to be able to spend $100 per month on entertainment. System 100 may restrict the spending ability of the child, i.e., the account user, accordingly based on “service type,” “cumulative transaction amount,” “frequency,” or other suitable restriction parameters. The same account holder may wish, however, that upon his or her death those parameters be automatically updated to permit the child to spend $500 per month on entertainment in light of the parent's passing. Alternatively, the parent may wish to adjust the transaction restriction parameters such that, following the parent's death, $5,000 of the account's total balance must be used for funeral services. In offering such functionality, system 100 may enable account holders to better plan for such events.

As discussed above, system 100 may receive an indication that the condition has been satisfied or that a specified event has occurred either manually, such as from a third-party approver, or automatically, such as from a third-party system associated with a medical provider. Upon activating the conditional parameters, system 100 may decline to accept further updates to the parameters based on advanced instructions from the account holder. In doing so, system 100 may effectively make the conditional parameters permanent.

In some embodiments, a third-party reviewer may automatically be granted further access to the account in response to the triggered condition or event. In some embodiments, although a designated third-party approver may have review and approval authority, the third-party approver may not have any ability to create or update transaction restriction parameters or, as discussed below, link parameters. Subject to account holder request, system 100 may grant the third-party review such authority following activation of a particular conditional parameter. As a result, system 100 may empower the third-party approver to effectively step into the shoes of the account holder in situations in which the account holder may have become incapacitated or otherwise incapable of managing his or her account.

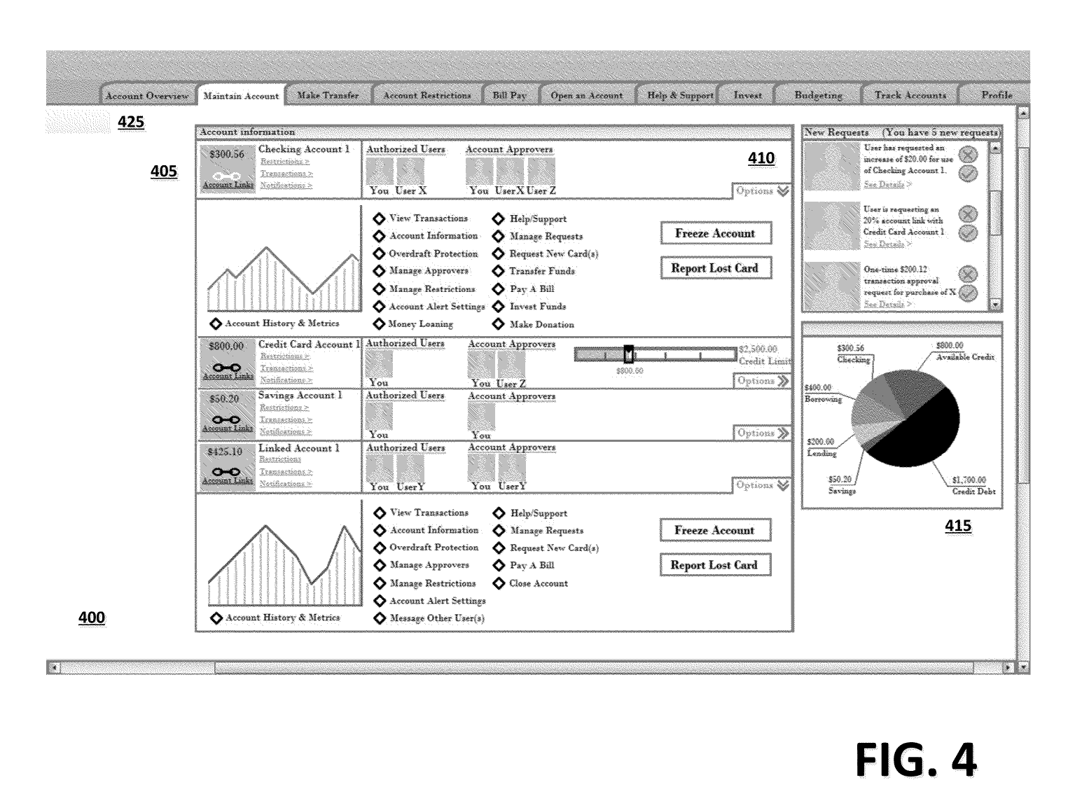

System 100 may further include an account user computing device 170. Account user computing device 170 may be communicatively coupled to server 110 by network 120. Account holder computing device 130 and account user computing device 170 may each be a desktop computer, laptop computer, tablet, netbook, smartphone (e.g., an iPhone produced by Apple Inc. of Cupertino, Calif.), or any other suitable computing device known in the art. Computing devices 130 and 170 may each have an application stored in memory that, when executed by a processor of the computing device, may cause the application to display a graphical user interface associated with system 100. An exemplary graphical user interface is displayed at FIG. 4. Using the graphical user interfaces displayed on account holder computing device 130 and/or account user computing device 170, an account holder and/or account user may communicate with system 100 to carry out the various functionalities described herein. In some cases, the account holder may be the same person or entity as the account user. However, in other cases the account holder may be distinct from the account user. In such cases, system 100 may serve as an intermediary between the account user and the account holder in the same manner described above with respect to multiple account holders.

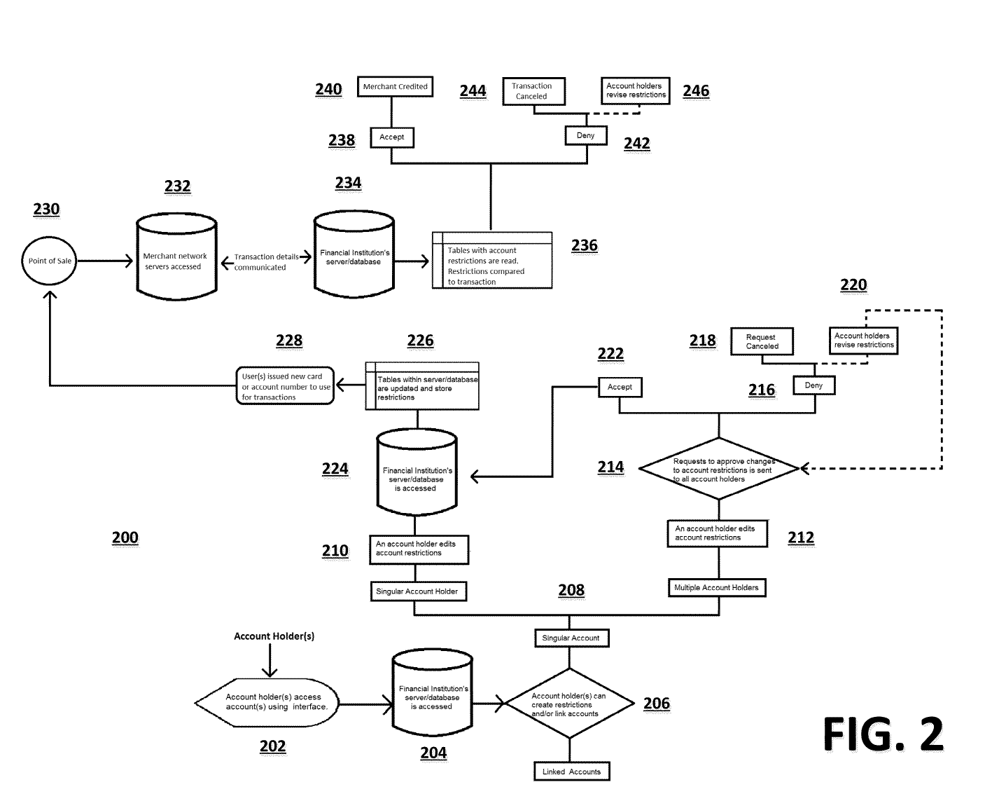

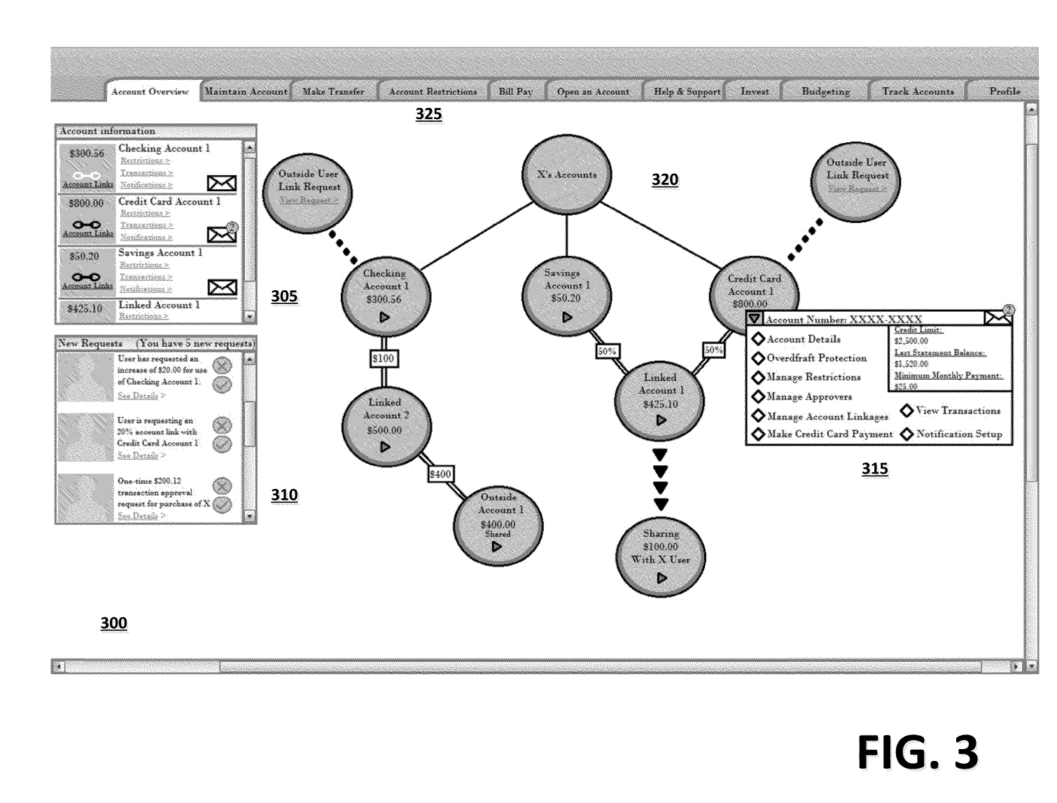

FIG. 2 is a block diagram that illustrates the operation of an exemplary transaction authorization control system 200. At block 202, an account holder may access an account using a graphical user interface displayed on an account holder computing device. The system may provide the account holder computing device with the data and instructions necessary to render and display the graphical user interface. The system may do so over a communications network to which the account holder computing device and a server or other suitable computing device of the system are communicatively coupled. An exemplary graphical user interface is shown at FIG. 3. As discussed above, the account holder may access the account by logging in using pre-established login credentials and any number of suitable login verification methods known in the art.

As shown at block 204, the system may grant access to the account holder by accessing a server or other capable computing device. For example, the system may access a financial institution server. In some embodiments, the financial institution server may include a database stored in memory. As previously discussed, the database may contain various transaction restriction parameters and other account data or information associated with the account.

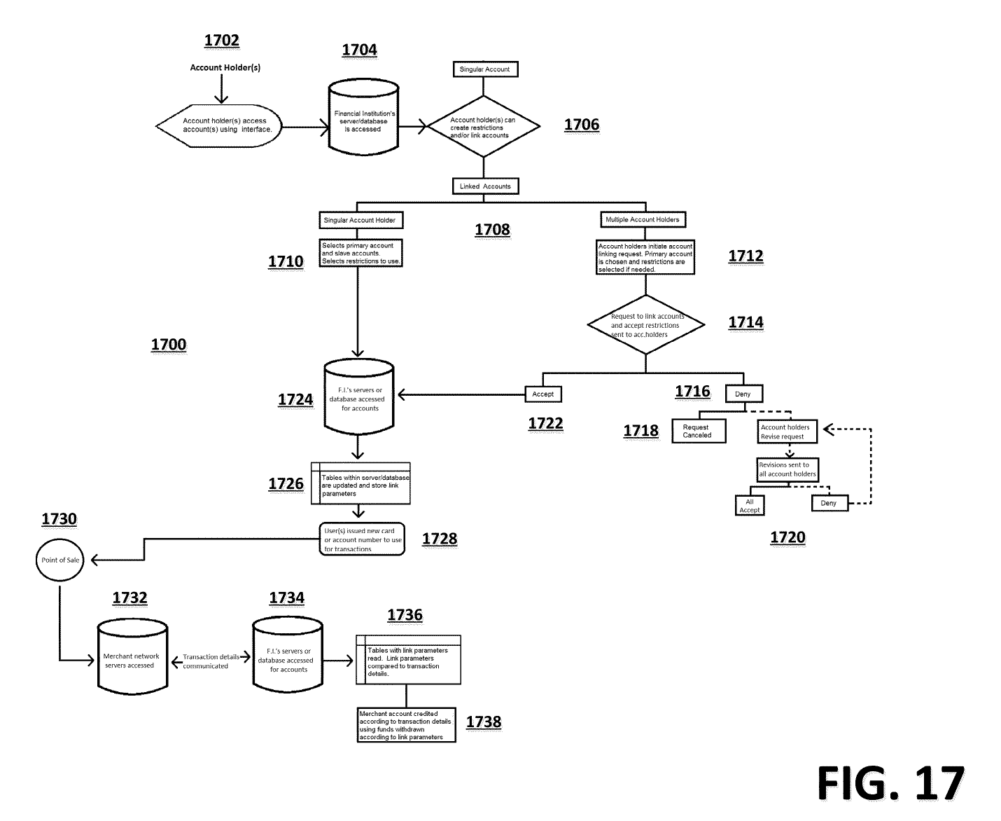

At block 206, the account holder may create or update transaction restriction parameters associated with the account by communicating with the system via the graphical user interface displayed on the account holder computing device. As discussed later with reference to FIG. 17, the account holder may also link multiple accounts communicating with the system via the graphical user interface displayed on the account holder computing device. At block 208, the system may determine whether the account is associated with a single authorized account holder or multiple authorized account holders.

At block 210, when the system determines that the account is associated with a single authorized account holder, the system may receive and approve any new or updated transaction restriction parameters created by the sole account holder. The account holder may do so by communicating with the system via the graphical user interface displayed on the account holder computing device.

At block 212, the system may receive a request to create or update a transaction restriction parameter from one of multiple account holders associated with an account. As shown at block 214, when the system determines that the account is associated with at least a second account holder, the system may require that all authorized account holders concur in any update to a transaction restriction parameter requested by any individual account holder. In such embodiments, creating or updating the transaction restriction parameter may include additional steps compared to when only one account holder is associated with the account. For example, in some embodiments, upon determining that the account is associated with a second account holder, the system may send to the second account holder a request to approve the update request received from the first account holder.

As shown at blocks 216 and 218, the second account holder may wish to outright deny the transaction restriction parameter update proposed by the first account holder. In such cases, in response to receiving a denial response from the second account holder, the system may cancel the proposed update and notify the first account holder that the second account holder refused to concur.

As shown at block 220, however, in some cases the second account holder may wish to counter-propose a transaction restriction parameter update. In such cases, the system may receive a counter-proposed transaction restriction parameter update from the second account holder. The system may then cycle back to block 214 and send a request to the first account holder to approve the counter-proposed transaction restriction parameter update. The system may allow for an unlimited number of negotiating rounds, or it may only allow for a limited number set by one or more of the account holders. In other embodiments, the system may not allow for any negotiating based on input received from one or more of the account holders. As shown at block 222, in some instances the second account may simply wish to approve the update request received from the first account holder and relayed to the second account holder by the system.

At block 224, the system may create or update transaction restriction parameters by accessing the server or other computing device having the transaction restriction parameters stored in memory. In some embodiments, as shown at block 224, the transaction restriction parameters may be stored in one or more databases. The database may further store the transaction restriction parameters in one or more tables as shown at block 226.

At block 228, the system may issue a new card or account number to an authorized account user associated with the account. In some cases, as discussed further below, multiple account users may be associated with a single account. In such cases, the system may issue a new card or account number to some or all of the multiple account users. In some embodiments, the system may not issue a new card or account number, but rather may allow the account user to continue using the same card and account number that the account user was using prior to the update.

At block 230, the account user may attempt to execute a transaction using credit or funds located in the account managed by the system. The account may be associated with any number of transaction devices known in the art, such as credit cards, debit cards, traditional checks, electronic checks, electronic fund transfers, and the like. For example, as shown at block 230, the account user may present to a merchant at a point of sale a credit card associated with an account managed by the system.

At block 232, the account and transaction details may be sent from the point of sale to a server associated with the merchant. The server associated with the merchant may then deliver the transaction details to the system and request authorization to proceed with the proposed transaction. As noted above, the system may include a server or other suitable computing device. For example, the system may include a financial institution server. In some embodiments, like that shown in FIG. 2, the server may include a database stored in memory and the database may include one or more tables for storing data. The database may contain various transaction restriction parameters and other information associated with the account, any of which may be stored in one or more of the tables.

At block 234, the system may receive the transaction request from the server associated with the merchant. The transaction request may include a plurality of transaction details. The system may receive the transaction request directly from a merchant server, or from an intermediary computing device such as a payment service provider server or some other third-party server.

At block 236, in response to receiving the transaction request, the system may execute instructions stored in memory. Execution of the instructions may cause the system to compare the transaction details to one or more transaction restriction parameters stored in memory. For example, as shown at block 236, the system may read a plurality of tables and compare the transaction details to the transaction restriction parameters. In doing so, system may determine whether the requested transaction is permissible in view of the scope of permissible transactions associated with the account, the scope of which may be defined by the transaction restriction parameters stored in memory.

At block 238, the system may approve or accept the transaction request when the transaction details do not violate or conflict with one or more transaction restriction parameters. In such cases, as shown at block 240, the system may proceed with paying or crediting the merchant according to the transaction details.

At block 242, the system may decline the transaction request when the transaction details violate or conflict with one or more transaction restriction parameters stored in memory of the system. At block 244, when a transaction is declined because it violates or conflicts with a transaction restriction parameter, the system may cancel or deny the transaction. In some embodiments, as shown at block 246, the system may notify the account holder associated with the account. In such embodiments, the system may notify the account holder that the transaction request was denied for violating or conflicting with one or more transaction restriction parameter. Where an account is associated with multiple account holders, the system may notify all account holders. In some embodiments, the system may notify less than all account holders to avoid notifying account holders who do not wish to receive notifications from the system.

As discussed above, the system may further suggest to the account holder an update to the transaction restriction parameter that would permit approval of the transaction request. The suggested update to the transaction restriction parameter may be a one-time update that reverts back to the previous transaction restriction parameter immediately following completion of the transaction. In such cases, the update may effectively serve as a “one-time exception” to the general transaction restriction parameter. In other embodiments, the suggested update to the transaction restriction parameter may be permanent subject to the account holder manually resetting the transaction restriction parameter using the systems and methods described herein. In still further embodiments, the system may provide the account holder with the option of approving the suggested update as a one-time exception or as the new general transaction restriction parameter moving forward.

FIG. 3 illustrates an exemplary graphical user interface that may displayed on an account holder computing device and used to interact with various functionalities of the system disclosed herein. An account overview window 300 may include a variety of panes, such as account information pane 305, new requests pane 310, and main control pane 315. Account overview window 300 may further display a graphical overview 320 of the account. As discussed in further detail below, the account may be linked to one or more other accounts according to various user-definable link parameters. Although account overview window 300 is primarily illustrated in FIG. 3, a number of additional tabs 325 are likewise visible, each of which may cause the system to display one of many other possible distinct windows when selected by the user using the graphical user interface. Some examples of such other windows include but are not limited to a “maintain account” window, a “make transfer” window, an “account restrictions” window, a “bill pay” window, an “open an account” window, a “help and support” window, an “invest” window, a “budgeting” window, a “track accounts” window, and a “profile” window.

FIG. 4 illustrates another exemplary graphical user interface that may displayed on an account holder computing device and used to interact with various functionalities of the system disclosed herein. A maintain account window 400 may include a variety of panes, such as account information pane 405, new requests pane 410, and account breakdown pane 415. Although maintain account window 400 is primarily illustrated in FIG. 4, a number of additional tabs 425 are likewise visible, each of which may cause the system to display one of many other possible distinct windows when selected by the user using the graphical user interface. For illustrative purposes, a number of such additional windows were previously described.

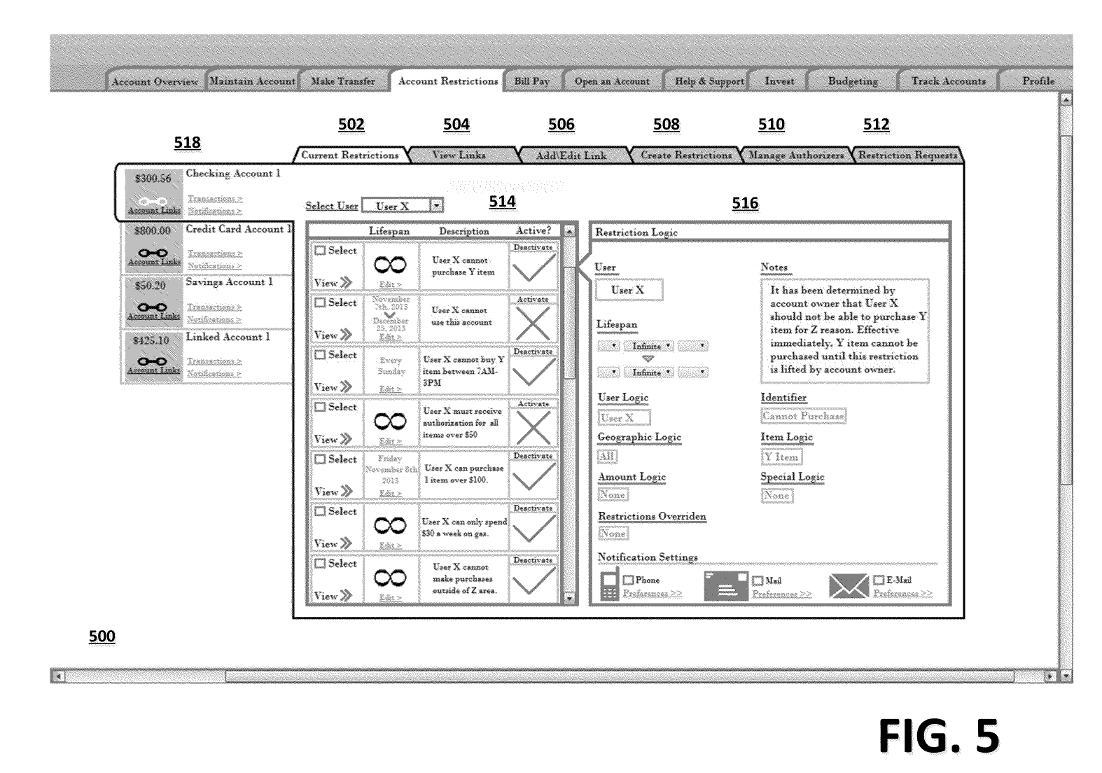

FIG. 5 illustrates another exemplary graphical user interface that may displayed on an account holder computing device and used to interact with various functionalities of the system disclosed herein. An account restrictions window 500 may include a variety of sub-windows, such as current restrictions sub-window 502, view links sub-window 504, add/edit link sub-window 506, create restrictions sub-window 508, manage authorizers sub-window 510, and update requests sub-window 512. Each of the aforementioned sub-windows may include various panes, tables, fields, regions, and the like. For example, as shown in FIG. 5, current restrictions sub-window 502 may include a restrictions table 514. When the account holder selects an individual restriction, the system may further cause the graphical user interface displayed on the account holder computing device to display a restriction logic pane 516 within current restrictions sub-window 502. Current restrictions sub-window 502 may further include an accounts list 518 that allows the account holder to switch between various accounts managed by the system disclosed herein.

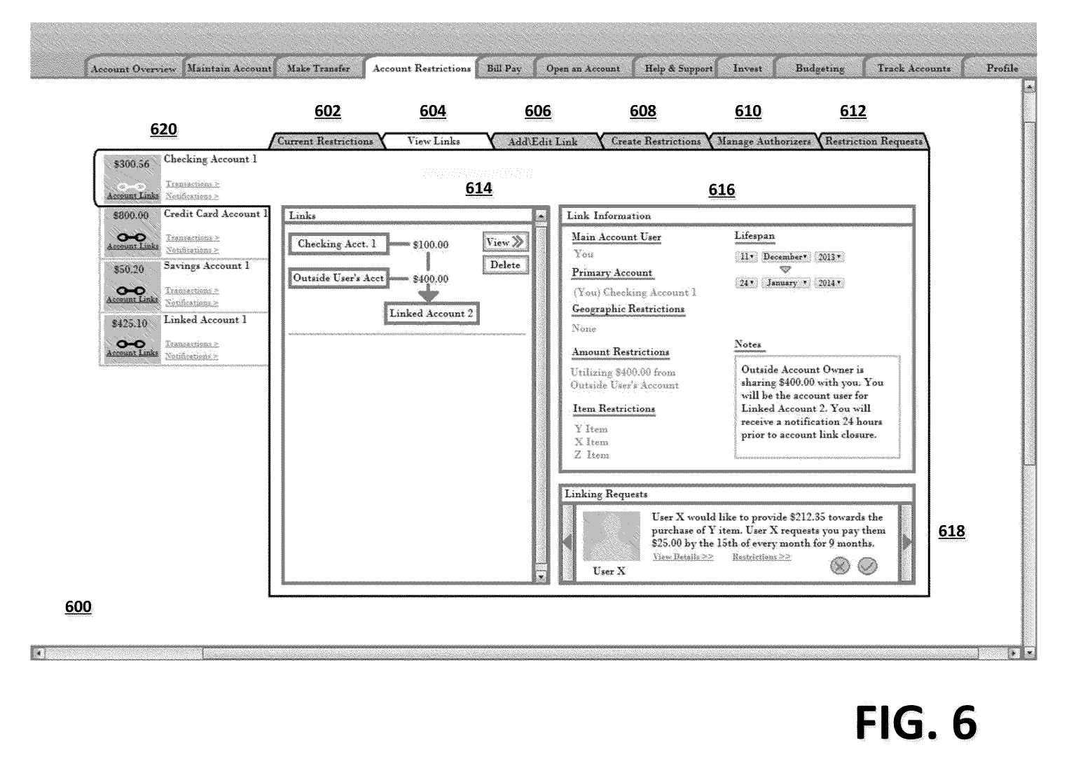

FIG. 6 illustrates another exemplary graphical user interface that may displayed on an account holder computing device and used to interact with various functionalities of the system disclosed herein. An account restrictions window 600 may include a variety of sub-windows, such as current restrictions sub-window 602, view links sub-window 604, add/edit link sub-window 606, create restrictions sub-window 608, manage authorizers sub-window 610, and update requests sub-window 612. Each of the aforementioned sub-windows may include various panes, tables, fields, regions, and the like. For example, as shown in FIG. 6, view links sub-window 604 may include a links pane 614. When the account holder selects an individual link, system 100 of FIG. 1 may further cause the graphical user interface displayed on the account holder computing device to display a link information pane 616 within view links sub-window 604. View links sub-window 604 may further include a linking requests pane 618. View links sub-window 604 may further include an accounts list 620 that allows the account holder to switch between various accounts managed by the system disclosed herein.

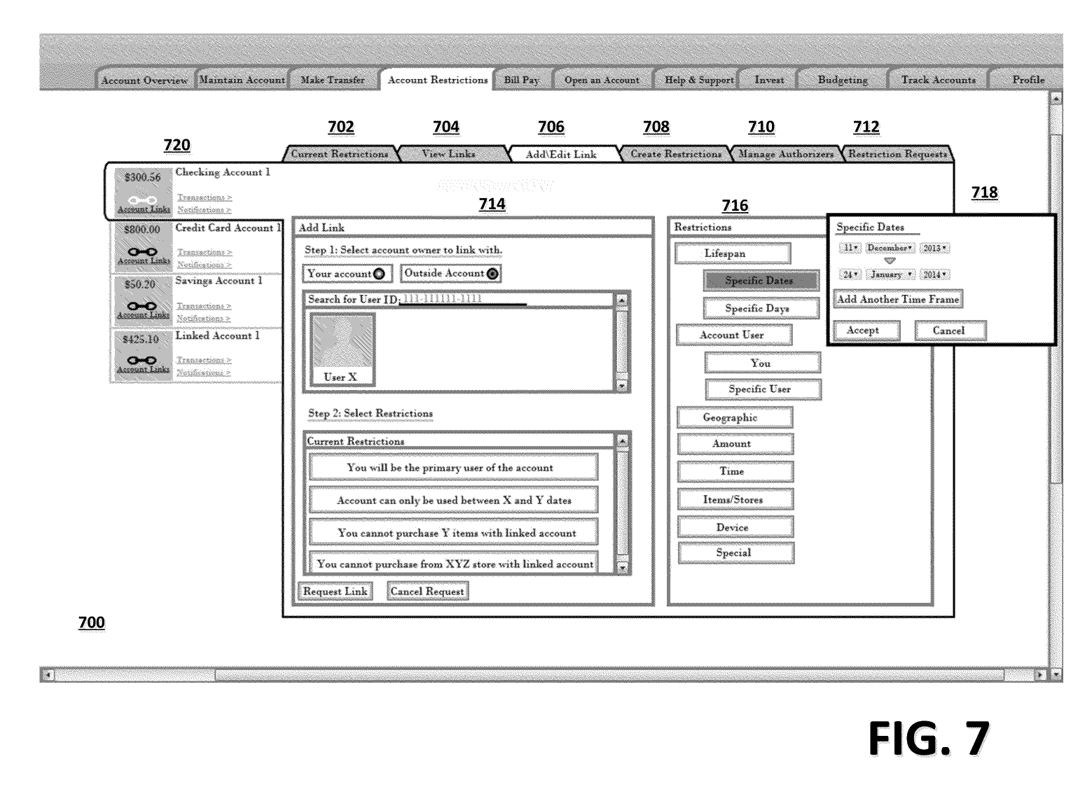

FIG. 7 illustrates another exemplary graphical user interface that may displayed on an account holder computing device and used to interact with various functionalities of the system disclosed herein. An account restrictions window 700 may include a variety of sub-windows, such as current restrictions sub-window 702, view links sub-window 704, add/edit link sub-window 706, create restrictions sub-window 708, manage authorizers sub-window 710, and update requests sub-window 712. Each of the aforementioned sub-windows may include various panes, tables, fields, regions, and the like. For example, as shown in FIG. 7, add/edit link sub-window 706 may include an add link pane 714. Add/edit link sub-window 706 may further include a restrictions pane 716.

Restrictions pane 716 may allow an account holder to place various restriction on a link. For example, an account user may restrict the lifespan of a link, the permitted account users associated with a link, or other parameters such as geography, fund amounts, time, types of items, types of merchants or stores, types of devices used to purchase items, and other special custom restrictions. When the account holder selects an restriction button within restrictions panel 716, the system disclosed herein may further cause the graphical user interface displayed on the account holder computing device to display a further sub-window containing user-configurable parameters specific to that restriction type. For example, as shown in FIG. 7, in one embodiment when an account holder selects the “Specific Dates” button in restrictions pane 716, the system further causes the graphical user interface displayed on the account holder computing device to display a dates sub-window 718 that contains user-configurable parameters for restricting the link to a specific time frame. View links sub-window 704 may further include an accounts list 720 that allows the account holder to switch between various accounts managed by the system.

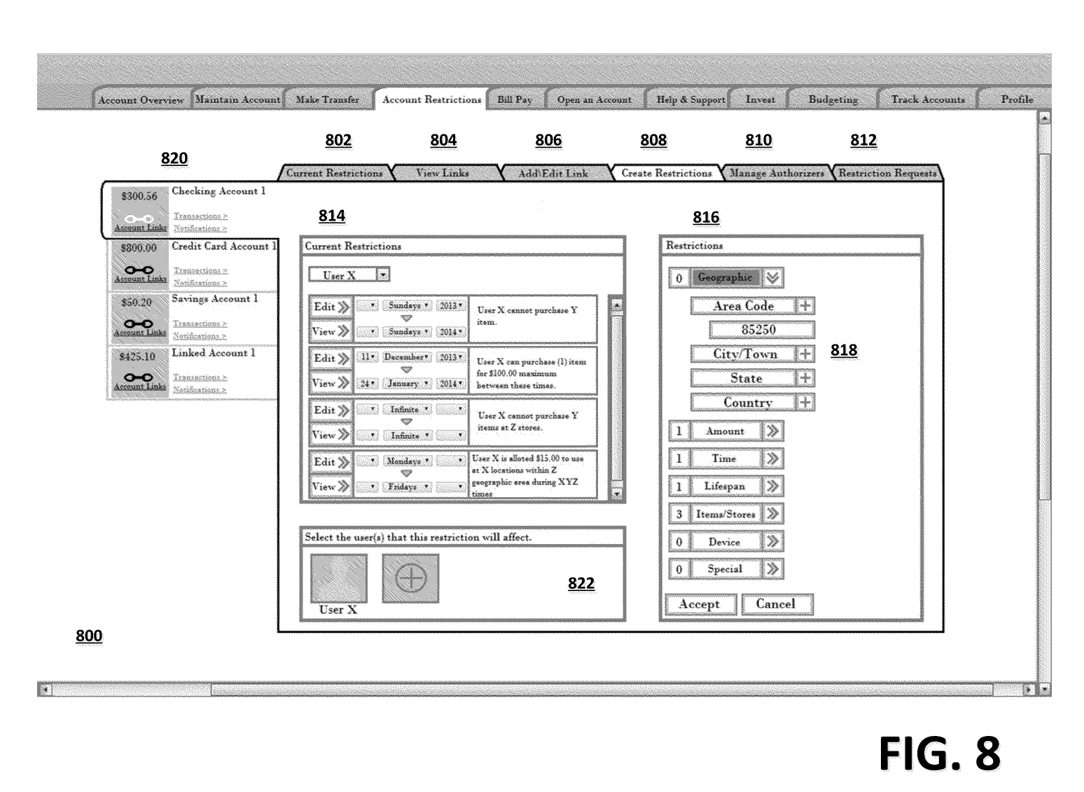

FIG. 8 illustrates another exemplary graphical user interface that may displayed on an account holder computing device and used to interact with various functionalities of the system disclosed herein. An account restrictions window 800 may include a variety of sub-windows, such as current restrictions sub-window 802, view links sub-window 804, add/edit link sub-window 806, create restrictions sub-window 808, manage authorizers sub-window 810, and update requests sub-window 812. Each of the aforementioned sub-windows may include various panes, tables, fields, regions, and the like. For example, as shown in FIG. 8, create restrictions sub-window 808 may include a current restrictions pane 814. Create restrictions sub-window 808 may further include a restriction creation/edit pane 816. Restriction creation/edit pane 816 may display an overview of transaction restriction parameters associated with an account, such as geographic restriction parameters, transaction amount restriction parameters, time restriction parameters, lifespan restriction parameters, item restriction parameters, merchant or store restriction parameters, device restriction parameters, or special customer restriction parameters.

Restriction creation/edit pane 816 may further allow an account holder to create or update a restriction by requesting that the system create or update one or more user-configurable transaction restriction parameters. For example, as shown in FIG. 8, an account holder may restrict an account based geography, fund amounts, time, types of items, types of merchants or stores, types of devices used to purchase items, and other special custom restrictions.

When the account holder selects an restriction button within restrictions panel 816, the system disclosed herein may further cause the graphical user interface displayed on the account holder computing device to display additional lists of sub-parameters specific to that general parameter type. For example, as shown in an embodiment illustrated in FIG. 8, when an account holder selects the “Geographic” transaction restriction parameter button in restrictions pane 816, the system further causes the graphical user interface displayed on the account holder computing device to display a list of sub-parameters 818 relating to geographic scope.

Each of the buttons, when clicked upon, such as when clicking the “+” symbol showed in list 818, may cause the system to display a field that receives data entered by the account holder. In FIG. 8, the account holder has entered zip code 85250 into the field associated with the area code sub-parameter. In response, the system receives the zip code information and uses it to restrict the account to transactions attempted within that particular zip code. Create restrictions sub-window 808 may further include an accounts list 820 that allows the account holder to switch between various accounts managed by the system. Create restrictions sub-window 808 may further include a user selection pane 822. At user selection pane 822, the system receives input from the account holder as to which account user(s) the current restriction should apply. For example, as shown in FIG. 8, the selected restriction is set to apply to User X. By way of the various input fields, selectable buttons, and configurable tools discussed herein, the system may receive details regarding the new or updated parameters that the account holder wishes to have stored in memory.

FIG. 9 illustrates another exemplary graphical user interface that may displayed on an account holder computing device and used to interact with various functionalities of the system disclosed herein. As noted above, the system may receive from an account holder information sufficient to identify a third-party whom the account holder wishes to have the authority to review and subsequently approve or deny an update request. Such information may be received through input fields or tools displayed on the graphical user interface of the account holder computing device. In one exemplary graphical user interface, an account restrictions window 900 may include a variety of sub-windows, such as current restrictions sub-window 902, view links sub-window 904, add/edit link sub-window 906, create restrictions sub-window 908, manage authorizers sub-window 910, and update requests sub-window 912. Each of the aforementioned sub-windows may include various panes, tables, fields, regions, and the like.

For example, as shown in FIG. 9, manage authorizers sub-window 910 may include a third-party approver management pane 912. Manage authorizers sub-window 910 may further include a level selector tool 914 through which an account holder may cause the system to display an approver relationship pane 916 at multiple levels, such as at the overall account level, the approver level, or the parameter level. Approver relationship pane 916 may be display the relationship between one or more authorized account holders and one or more third-party approvers. Approver relationship pane 916 may contain textual representations, graphical representations, or a combination thereof. For example, as shown in FIG. 9, approver relationship pane 916 displays an interactive block diagram 918 featuring both textual representations, graphical representations, and selectable regions that, when selected by the account holder, may cause the system to display one or more additional informational panes. Interactive block diagram 918 may represent each third-party approver configured by an account holder as a block element. The block element may include a photograph or avatar associated with each third-party approver. Moreover, the block element may include an “edit” button, a “view” button, or other regions selectable by the account holder to carry out additional functionalities.

As shown in FIG. 9, exemplary interactive block diagram 918 illustrates that account holder 920 has added third-party approver A 922 to the list of individuals capable of reviewing and approving update requests. Interactive block diagram 918 further illustrates account holder 920 has also added a second level of third-party approvers comprising third-party approver B 924 and third-party approver C 926. The system may allow account holder 920 to configure certain parameters governing the rights of each third-party approver or any requirements associated with relationships among multiple third-party approvers like third-party approver B 924 and third-party approver C 926. For example, as shown in FIG. 9, each block representing a single third-party approver includes an “edit” button and a “view” button. When the “edit” button is selected by the account holder, it may because the system to display an additional pane containing configurations tools for creating or updating the parameters governing the selected third-party approver. When the “view” button is selected, the system may display a similar window that displays the information and parameters currently in place. For example, as shown in FIG. 9, account holder 920 has selected a “view” button 928 displayed within the block corresponding to third-party approver C 926. In response, the system has displayed an additional viewing pane 930 that displays the information and parameters currently related to or governing third-party approver C 926.

Viewing pane 930 may include information such as the name of third-party approver C 926, or it may contain parameters governing the ability of third-party approver C 926 to approve an update request. As shown in FIG. 9, viewing pane 930 indicates that ability of third-party approver C 926 to approve update requests is subject to two parameters configured by account holder 918. Namely, third-party approver C 926 can only approve an update request if third-party approver B 924 also approves the same update request. In other words, by using the configurable parameter tools provided by the system, account holder 920 has created a parameter that requires third-party approver B 924 and third-party approver C 926 to concur in approving any update request. Viewing pane 930 further indicates that third-party account approver C 924 is barred from approving any update requests that might permit the system to approve a transaction request over $500.

Viewing pane 930 may further include several optional notification avenues through which, at the request of the account holder, the system may send a notification by phone, text message, mail, or e-mail to any party involved in interactive block diagram 918. The notification may include notice that account holder 918 has updated information or parameters associated with that or other parties in the interactive block diagram 918. For example, using the graphical user interface displayed in FIG. 9, account holder 920 may delete the requirement “must approve with Approver B” from the list of parameters governing the approval rights of third-party approver C 926. Account holder 920 may further select the e-mail notification option before accepting the configured change. When the account holder 920 selects an “accept” button 932, the system may receive the inputted information, update a plurality of third-party approver data stored in memory of a server or other suitable computing device, and also automatically transmit an e-mail notification to account holder 920, third-party account holder B 922, and/or third-party account holder C 924. The system may receive the new or updated third-party approver data in memory of a server or other suitable computing device much in the same way that it may store standard account data, such as account balances, or transaction restriction parameters and/or link parameters. Manage authorizers sub-window 908 may further include an accounts list 934 that allows the account holder to switch between various accounts managed by the system.

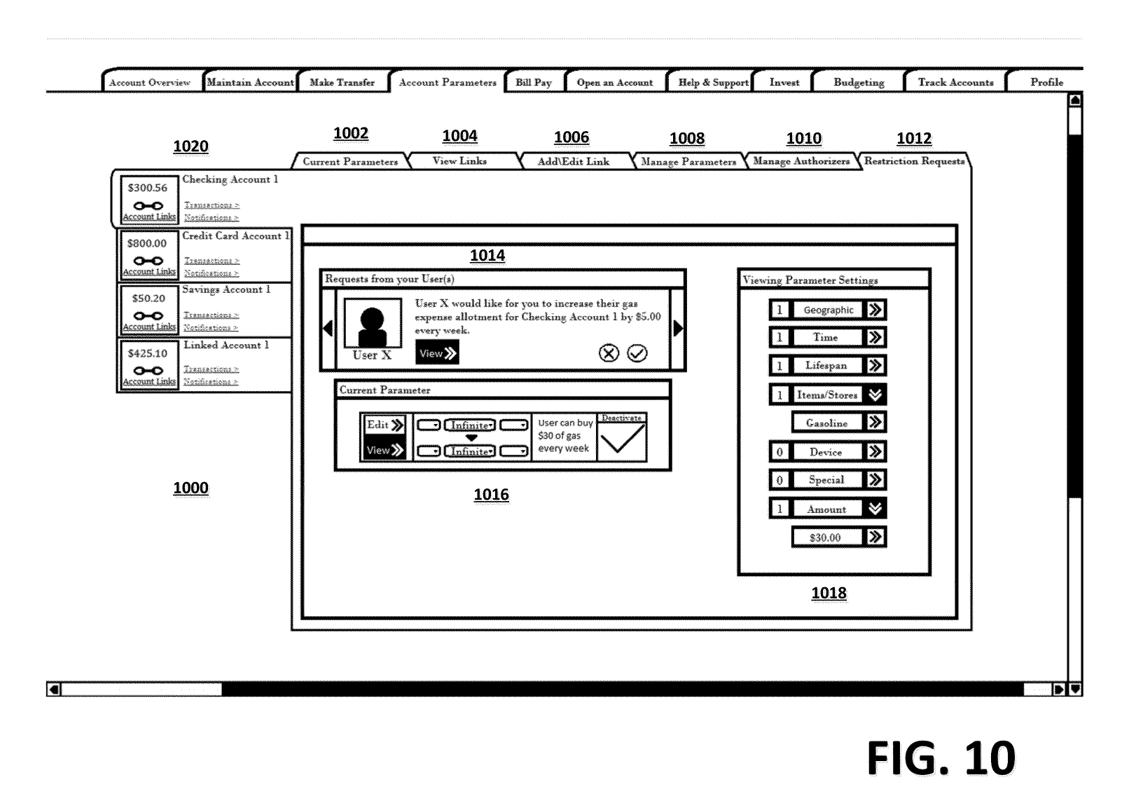

FIG. 10 illustrates another exemplary graphical user interface that may displayed on an account holder computing device and used to interact with various functionalities of the system disclosed herein. The system may receive from an account user an explicit request that one or more transaction restriction parameters be updated by the account holder. As discussed in further detail later, the system may also receive from an account user an explicit request that one or more link parameters be updated by the account holder. Such information may be received through input fields or tools displayed on the graphical user interface of the account user computing device. In one exemplary graphical user interface, an account restrictions window 1000 may include a variety of sub-windows, such as current restrictions sub-window 1002, view links sub-window 1004, add/edit link sub-window 1006, create restrictions sub-window 1008, manage authorizers sub-window 1010, and update requests sub-window 1012. Each of the aforementioned sub-windows may include various panes, tables, fields, regions, and the like.

For example, as shown in FIG. 10, update requests sub-window 1012 may include an update request notification window 1014. Update request notification window 1014 may display information about an update request that an account user submitted to the system. Update request notification window 1014 may identify the account user that submitted the update request and provide details about the requested adjustment to the transaction restriction parameter at issue. For example, in FIG. 10, update request notification window 1014 informs the account holder that the system has received an update request from User X. Update request notification window 1014 may further provide a description of the adjustment to the existing transaction restriction parameter that User X has requested. In the example shown in FIG. 10, User X has requested that the account holder increase User X's gas expense allotment for Checking Account 1 by $5 every week. In other words, User X wants the system to replace the transaction restriction parameter stored in memory of the financial institution server or other applicable computing device with an updated transaction restriction that will better suit User X's needs. Update request notification window 1014 may include a selectable “view” or “details” button that, when selected by the account holder, may display an additional sub-window, such as current parameter sub-window 1016.

Current parameter sub-window 1016 may identify and display details about the transaction restriction parameter that the account user wants the system to update. In the example shown in FIG. 10, the transaction restriction parameter limiting User X is “User can buy $30 of gas every week.” Current parameter sub-window 1016 may likewise include a selectable “view” or “details” button that, when selected by the account holder, may display an additional sub-window, such as parameter settings sub-window 1018.

Parameter sub-window 1018 may display the user-friendly configuration tools that the account holder may utilize to create the logic governing the transaction restriction parameter at issue. In FIG. 10, parameter sub-window 1018 indicates that the transaction restriction parameter at issue—“User can buy $30 of gas every week”—is governed by at least two sub-parameters—an “item/store” sub-parameter limiting the type of item that may be purchased to “gasoline” and another limiting the maximum transaction amount for such purchases to $30.” The transaction restriction parameter could include a number of other sub-parameters, such as limitations on how long the transaction restriction parameter should remain in effect (e.g., the “lifespan” parameter), which hours of the day the transaction restriction parameter should be active (e.g., between 11:00 PM and 6:00 AM), and any number of other suitable sub-parameters, including special sub-parameters customized by the account holder. For example, although not expressly illustrated in FIG. 10, the transaction restriction parameter limiting User X to $30 of gas per week may also include a “frequency” sub-parameter limiting the number of transactions that may be approved, or in some embodiments specifying the frequency with which the portion of the maximum transaction amount used should be reset to zero. Update requests sub-window 1008 may further include an accounts list 1020 that allows the account holder to switch between various accounts managed by the system.

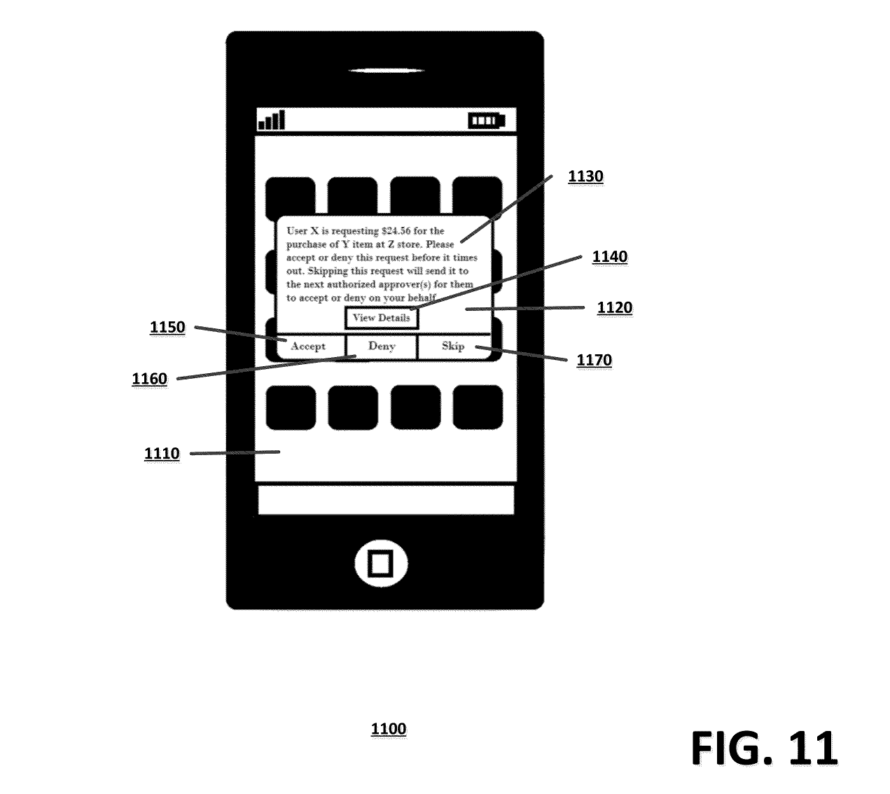

FIG. 11 illustrates another exemplary graphical user interface that may displayed on an account holder computing device and used to interact with various functionalities of the system disclosed herein. Graphical user interface 1100 may be used to communicate notifications and suggested updates to an account holder. For example, a mobile application may be installed upon an account holder computing device. The mobile application may include instructions that, when executed, cause the account holder computing device to render and display graphical user interface 1100 to the account holder. Graphical user interface 1100 may include a main display region 1110.

The system may communicate notifications and suggest updates to an account holder in a variety of ways. For example, as shown in FIG. 11, the account holder computing device may be a smartphone, tablet computer, or other mobile computing device and the system may send a “push notification” to the account holder computing device. The push notification may appear as a notification window 1120 within main display region 1110 of graphical user interface 1100. Notification window 1120 may continue a notification 1130. Notification 1130 may include a text-based explanation regarding an attempted interaction with an account associated with the account holder. For example, notification 1130 may explain that an account user associated with the account attempted to make a purchase that conflicted with or violated a transaction restriction parameter set by the account holder and stored in memory of the system. Notification 1130 may further inform the account holder that an attempted transaction was canceled or denied. In some embodiments, notification 1130 may further suggest to the account holder an update to the transaction restriction parameter that would permit approval of the transaction request.

Notification window 1120 may further include a “details” button 1140 that, when selected by the account holder, allows the account holder to view additional details regarding the attempted transaction. Notification window 1120 may further include an “accept” button 1150. When accept button 1150 is selected by the account holder, the system may receive an approval response from the account holder computing device. Notification window 1120 may further include a “deny” button 1160. When deny button 1160 is selected by the account holder, the system may receive a denial response from the account holder computing device.

In some embodiments, notification window 1120 may further include a “skip” button 1170. Skip button 1170 may be displayed when an account is associated with more than one account holder. In such cases, the system may allow a first account holder to defer to the decision of a second account holder by passing the request along to the second account holder. For example, when skip button 1170 is selected by the account holder, the system may receive a skip response from the account holder computing device. Upon receiving the skip response, the system may transmit the same notification to the second account holder. In some embodiments, the notification to the second account holder may include a remark that the first account holder has deferred to the judgment of the second account holder as to whether the transaction restriction parameter should be updated to permit the transaction attempted by the account user.

Notification window 1120 may further include a “transaction time out” countdown 1180. Transaction time out countdown 1180 may inform the account holder as to the time window in which the system must receive a response from the account holder via the account holder computing device before the system handles the transaction at issue according to a default action. For example, in FIG. 11, the system has notified the account holder through notification window 1120, and more specifically through time out countdown 1180, that the account holder must either accept, deny, or skip the request in the next two minutes and fifty-six seconds.

In some embodiments, the system's default response may be to leave the status quo transaction restriction parameter unmodified. In such cases, the system may simply deny the transaction request because the transaction details contained therein indicate that the proposed transaction conflicts with or violates the transaction restriction parameter. In other embodiments, the system's default response may be to automatically approve the minimum transaction restriction parameter update necessary to approve the transaction request (i.e., necessary to avoid a conflict between the requested transaction details and the transaction restriction parameter). Where an account is associated with multiple account holders, the system's default response when a notification times out may be automatically defer to one or more of the other account holders associated with the account. In such cases, the system may automatically transmit the same notification to the appropriate other account holders.

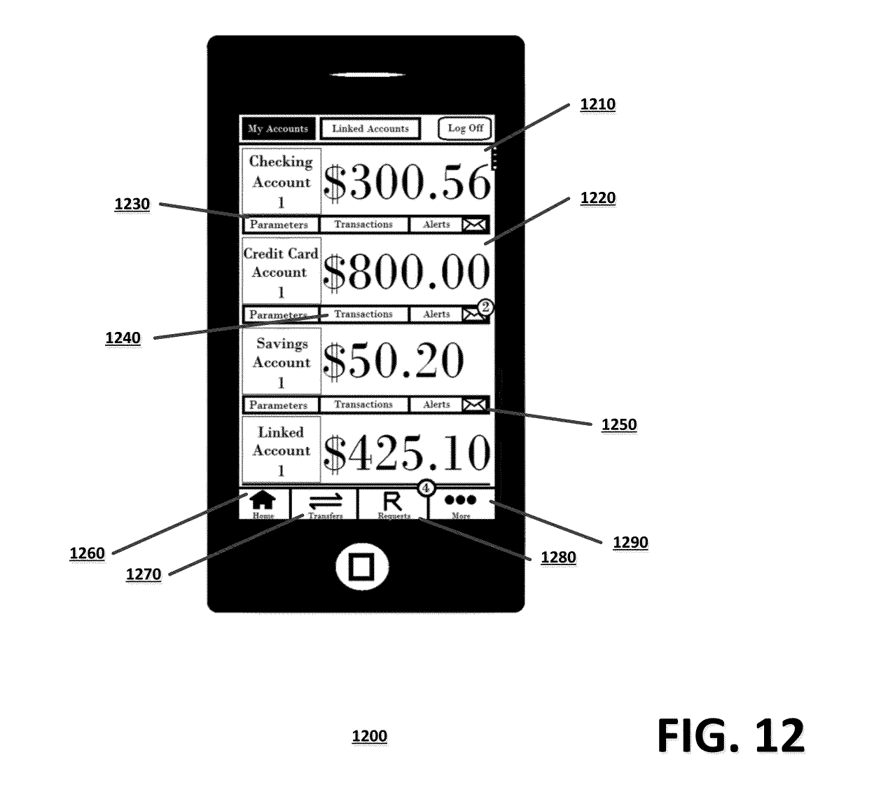

FIG. 12 illustrates another exemplary graphical user interface that may displayed on an account holder computing device and used to interact with various functionalities of the system disclosed herein. Graphical user interface 1200 may contain a number of display windows through which the system may communicate information to an account holder. Graphical user interface 1200 may be integrated into or may work in conjunction with a graphical user interface associated with financial institution account management tools.

Graphical user interface 1200 may include an account overview page 1210. Account overview page 1210 may include an account list 1220. Account list 1220 may display one or more accounts associated with an account holder. For example, as shown in FIG. 12, account list 1220 may include: a checking account labeled “Checking Account 1” with a balance of $300.56; a credit card account labeled “Credit Card Account 1” with a balance of $800.00; a savings account labeled “Savings Account 1” with a balance of $50.20, and a linked account labeled “Linked Account 1” with a balance of $425.10. Graphical user interface 1200 may contain a number of selectable buttons through which an account holder may communicate with the system. For example, graphical user interface 1200 may contain a “parameters” button 1230, a “transaction” button 1240, an “alerts” button 1250, a “home” button 1260, a “transfers” button 1270, a “requests” button 1280, or a “more” button 1290. In some embodiments, some of the selectable buttons may direct the account holder to other graphical user interfaces related to communicating with other systems that may be related to or entirely separate from the system and methods disclosed herein. For example, the foregoing may be particularly likely where graphical user interface 1200 is integrated into or works in conjunction with a broader financial institution account management system.

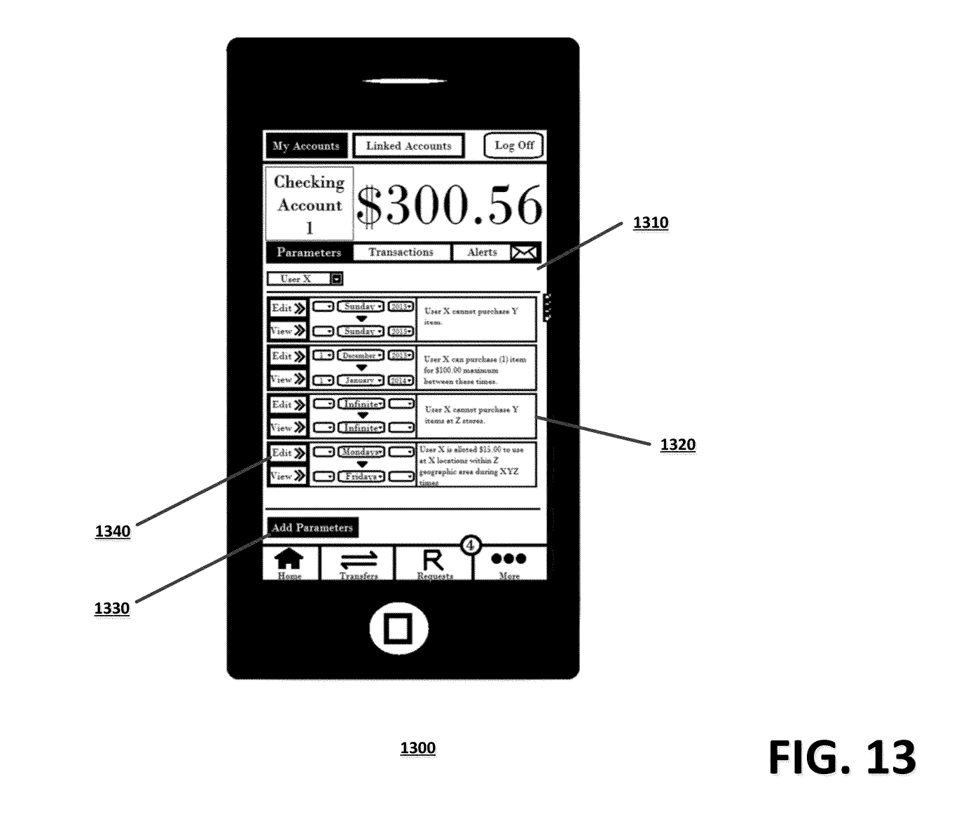

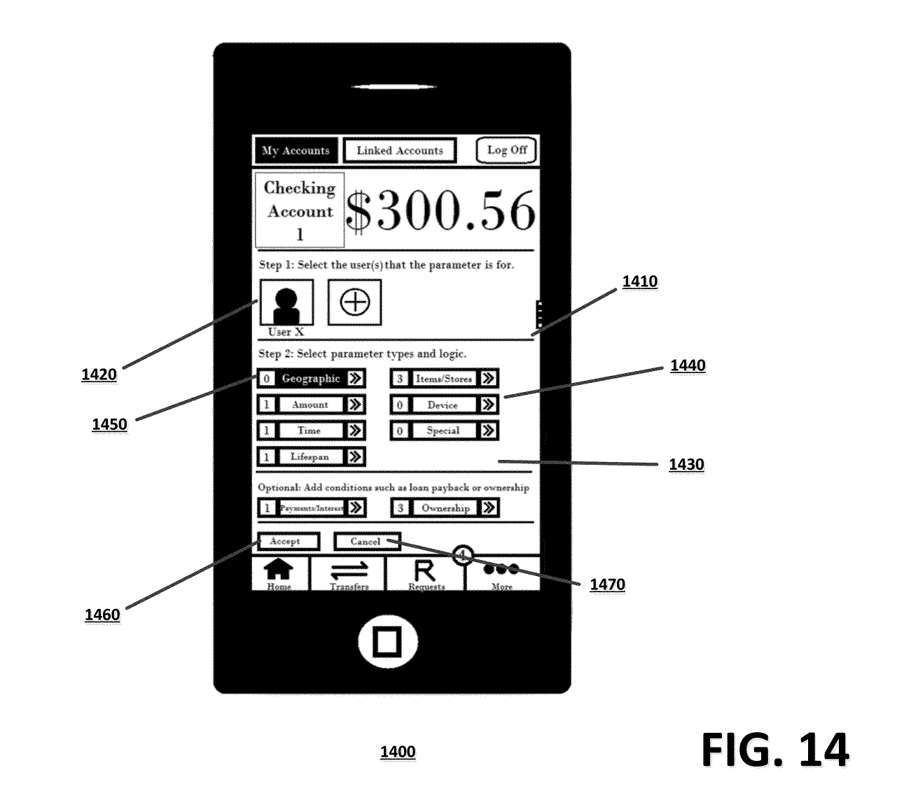

FIG. 13 illustrates another exemplary graphical user interface that may displayed on an account holder computing device and used to interact with various functionalities of the system disclosed herein. Upon selection of the parameters button 1230 of FIG. 12 by the account holder, the system may display a further graphical user interface that displays an overview of the current transaction restriction parameters associated with the account. For example, as shown in FIG. 13, upon selecting parameters button 1230 of FIG. 12, the system may display a restrictions overview window 1310. Restrictions overview window 1310 may include a list 1320 of the current transaction restriction parameters associated with the account. Each row in list 1320 may include information about a transaction restriction parameter, including a brief description of the parameter and the timeframe in which the parameter is set to remain active. List 1320 may include an “add restrictions” button 1330, which when selected by the account holder may cause the system to display a further graphical user interface like that shown in FIG. 14 discussed below. List 1320 may further include “edit” and/or “view” buttons 1340, which when selected by the account holder may cause the system to display a further graphical user interface similar shown in FIG. 14 discussed below.

FIG. 14 illustrates another exemplary graphical user interface that may displayed on an account holder computing device and used to interact with various functionalities of the system disclosed herein. Upon selecting add parameters button 1330 of FIG. 13, the system may display a further graphical user interface that displays a plurality of data fields and configuration tools associated with an individual transaction restriction parameter. Using the configuration tools, an account holder may create or update transaction restriction parameters associated with the account. For example, as shown in FIG. 14, upon selecting parameters button 1330 of FIG. 31, the system may display a transaction restriction parameter window 1410. Transaction restriction parameter window 1410 may include a user selection pane 1420 and a restriction parameter configuration pane 1430. User selection pane 1420 may inform the account holder as to how many and with which account users the transaction restriction parameter is currently or will be associated. For example, as shown in FIG. 14, user selection pane 1420 indicates that the transaction restriction parameter is associated with User X. User selection pane 1420 may contain a button for adding additional account users. The system may require receipt of a unique user identification number or other designator associated with the added account user.

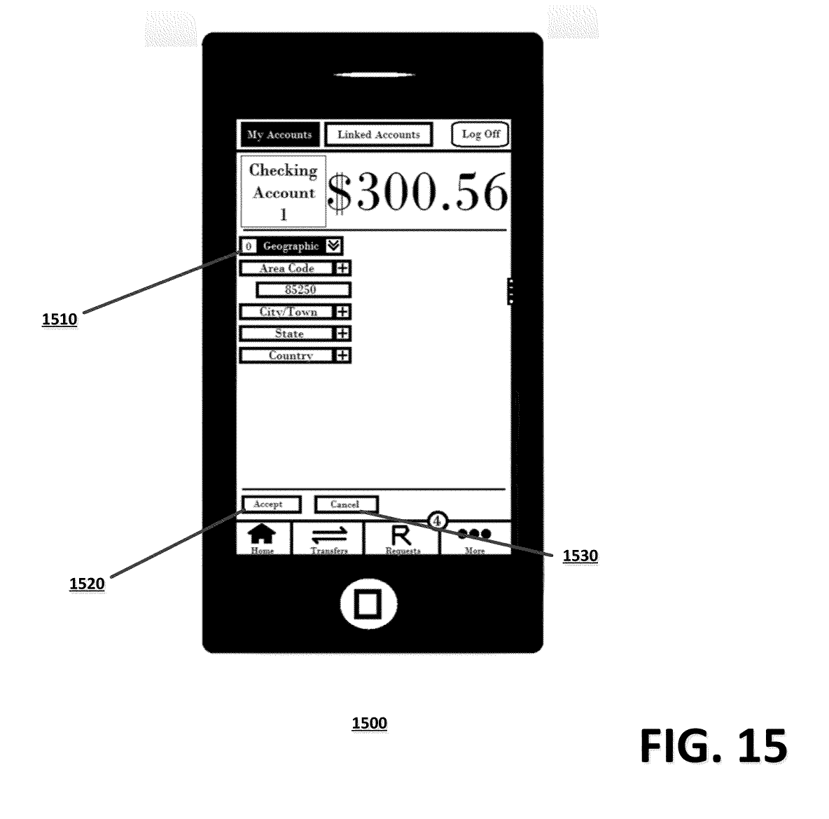

User selection pane 1420 may also inform the account holder as to how many and which types of restriction sub-parameters govern the greater selected transaction restriction parameter. User selection pane 1420 may display the various restriction logics as list 1440. For example, in FIG. 14, list 1440 displays restriction sub-parameter by geography, transaction amount, time, lifespan, item, store, and purchase device. List 1440 may further display a data field associated with special custom parameters. Multiple restriction sub-parameters of the same category may be added to govern a single transaction restriction parameter. Each restriction sub-parameter category may be displayed as a selectable button 1450. For example, in FIG. 14, the transaction restriction parameter is governed by one amount sub-parameter, one time sub-parameter, one lifespan sub-parameter, and three item or store sub-parameters. Accordingly, the system has stored in memory of a computing device, such as server 110 of FIG. 1, data and/or logic corresponding to each of the aforementioned sub-parameters. Upon selection of the “geographic” sub-parameter button 1450 by the account holder, the system may display a further graphical user interface associated with further restriction logic that governs the “geographic” sub-parameter. One illustrative example of such a graphical user interface is shown at FIG. 15 and discussed further below. Graphical user interface 1400 may further include an “accept” button 1460 and a “cancel” button 1470, which when selected by the account holder may respectively cause the system to proceed with or abandon the transaction restriction parameter update process described above.

FIG. 15 illustrates another exemplary graphical user interface that may displayed on an account holder computing device and used to interact with various functionalities of the system disclosed herein. Upon selecting a sub-parameter button 1450 of FIG. 14, the system may display a further graphical user interface that displays a plurality of data fields and configuration tools associated with an individual restriction sub-parameter. Using the configuration tools, an account holder may create or update the underlying logic governing a restriction sub-parameter. For example, as shown in FIG. 15, upon selection of the “geographic” sub-parameter button 1450 of FIG. 14 by the account holder, the system may display graphical user interface 1500. Graphical user interface 1500 may include a plurality of configuration tools 1510 associated with an individual restriction sub-parameter. Configuration tools 1510 may be selectable buttons, drop-down fields, or any other suitable data input mechanism known in the art. In the example shown in FIG. 15, the system displays multiple fields that the account holder may interact with to define the scope of the geographic sub-parameter. For example, the system may receive from the account holder a particular zip code with which to govern the geographic sub-parameter. Graphical user interface 1500 may further include an “accept” button 1520 and a “cancel” button 1530, which when selected by the account holder may respectively cause the system to proceed with or abandon the transaction restriction parameter update process described above.

### Account Holder-Account User Negotiated Transaction Restriction Parameters

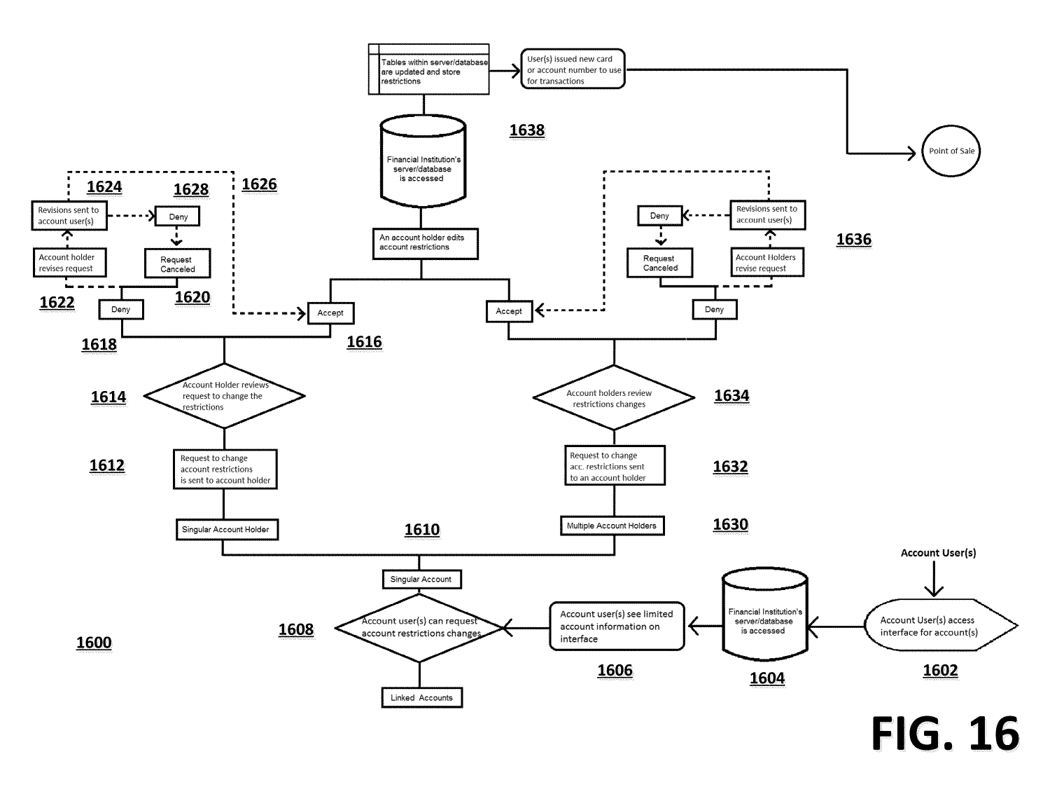

FIG. 16 is a block diagram that illustrates the operation of an exemplary transaction authorization control system. At block 1602, an account user may access an account using a graphical user interface displayed on an account user computing device. By sending and receiving data over a network communicatively coupled to a network interface of a server or other suitable computing device, the system may provide the account user computing device with the data and instructions necessary to render and display the graphical user interface. Alternatively, the data and instructions necessary for rendering the graphical user interface may be downloaded as a separate application. For example, an iPhones user might download a mobile application associated with or incorporated within the system from the Apple App Store. The graphical user interface available to the account user may be similar to one or more of the exemplary graphical user interfaces shown and discussed herein with respect to the account holder. The account user may access the account by logging in using pre-established login credentials and any number of suitable login verification methods known in the art.

As shown at block 1604, when the account user successfully logs into the account, the server or other capable computing device may be accessed. For example, a financial institution server may be accessed. In some embodiments, the financial institution server may include a database stored in memory. As previously discussed, the database may contain various transaction restriction parameters and other information associated with the account.

At block 1606, the account user may be able to view account information through the graphical user interface displayed on the account user computing device. Unlike when an authorized account holder accesses the financial institution server using the graphical user interface displayed on the account holder computing device, an account user distinct from the account holder may be limited to viewing basic account information through the graphical user interface displayed on the account user computing device. For example, where a mother is an authorized account holder for an account that her daughter, i.e. the account user, is permitted to use for certain school-related purchases, the mother and daughter may have access to different features and functionalities when accessing the financial institution service by logging into a mobile application on their respective smartphones. The daughter may only be able to view basic account information, such as an account balance and any transaction restriction parameters imposed by her mother. The mother may be able to see account information, the state of any past or present transaction restriction parameters, and a plurality of configurable tools for creating or updating such parameters. In some embodiments, the account user may also be able to view and utilize configuration tools to propose adjustments or updates to any transaction restriction parameter by the account holders.

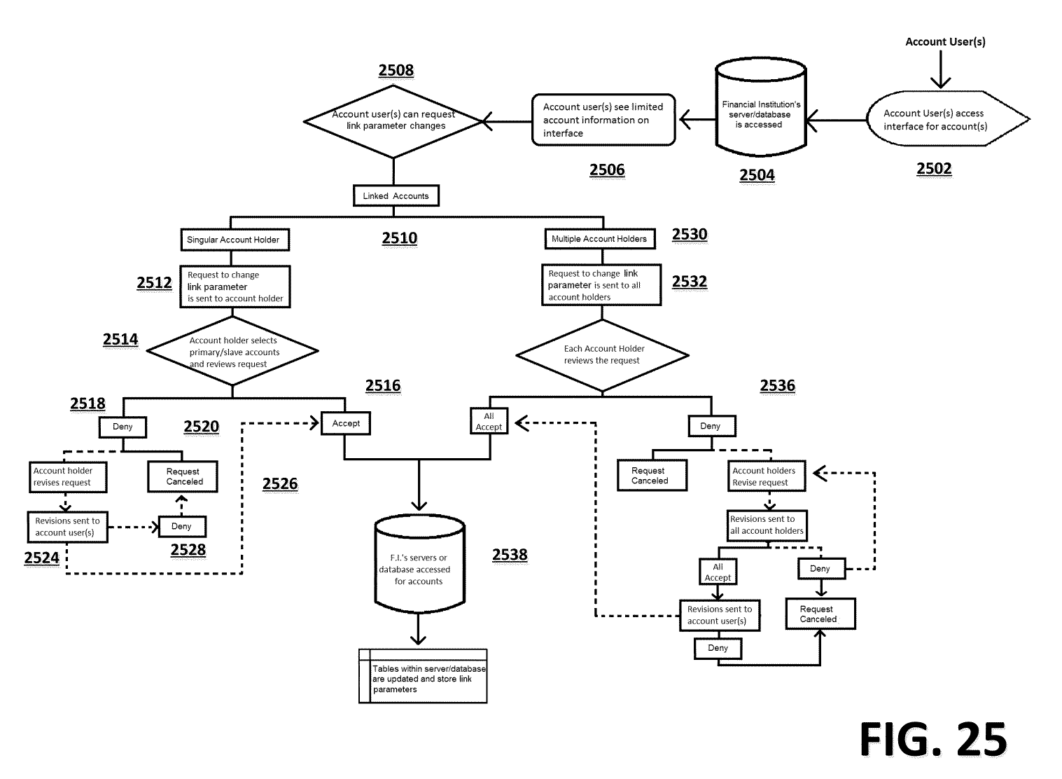

At block 1608, the server may receive from the account user a request to adjust or update a transaction restriction parameter stored in memory and associated with the account that the account user desires to use. The server may communicate with the account user via the graphical user interface displayed on the account user computing device. For example, in some embodiments, the request may originate when the account user uses the graphical user interface displayed on the account user computing device to configure a proposed update to an existing transaction restriction parameter and selects a “Send Request” button displayed thereon. The account user computing device, having been communicatively coupled to the server over a communications network, may then transmit the update request to the server. As discussed later with reference to FIG. 25, the account user may also request adjustments to account link parameters by communicating with the system via the graphical user interface displayed on the account user computing device.

At block 1610, the system may determine whether the account is associated with a single authorized account holder or multiple authorized account holders.

At block 1612, when the system determines that the account is associated with a single authorized account holder, the system may forward the update request to the sole account holder.

At 1614, the account holder may review the update request on the graphical user interface displayed on the account holder computing device. As described above with respect to FIG. 11, the update may appear on the graphical user interface as a “push notification,” a text message, an e-mail, or any other suitable form of notification.

At 1616, the account holder may accept the update request sent by the account user. The account holder may do so by selecting an “Accept Request” or similar button displayed either within the user request itself or within a separate area of the graphical user interface displayed on the account user computing device. For example, as discussed with reference to FIG. 11, a notification window may include a “details” button that, when selected by the account holder, allows the account holder to view additional details regarding the update request. The notification window may further include an “accept” button. When accept button is selected by the account holder, the system may receive an approval response from the account holder computing device.

In some embodiments, the notification window may further include a “skip” button. The skip button may be displayed when the account holder has configured the system to associate the account with a third-party reviewer in addition to the account holder. Alternatively the skip button may be displayed when an account is associated with more than one account holder. When the skip button is selected by the account holder, the system may receive a skip response from the account holder computing device. Upon receiving the skip response, the system may transmit the same notification to the computing device of the next appropriate account holder or, if applicable, a computing device belonging to a third-party reviewer. In some embodiments, the notification to the next account holder or third-party reviewer may include a remark that the account holder has deferred to the judgment of the next account holder or third-party reviewer as to whether the transaction restriction parameter should be updated pursuant to the request from the account user.

At block 1618, the account holder may deny the update request sent by the account user. A graphical user interface identical or similar to that shown in FIG. 11 may be displayed on the account holder computing device. The notification window may include a “deny” button. When the deny button is selected by the account holder, the system may receive a denial response from the account holder computing device.

As shown at block 1618, the account holder may wish to outright deny the transaction restriction parameter update proposed by the account user. In such cases, as shown at 1620, in response to receiving a denial response from the account holder, the system may cancel the proposed update and notify the account user that the account holder refused to approve the update request.

As shown at block 1622, however, in some cases the account holder may wish to counter-propose a transaction restriction parameter update. In such cases, the system may receive a counter-proposed transaction restriction parameter update from the account holder. The system may receive the counter-proposed transaction restriction parameter through a number of configurable fields and tools displayed on the graphical user interface of the account holder computing device, many illustrative examples of which are shown throughout the figures and drawings disclosed herein.

At block 1624, the system may transmit the counter-proposed transaction restriction parameter to the account user computing device. The system may notify the account user that he or she has received a counter-proposed transaction restriction parameter much in the same way that the system may notify an account holder of a pending an update request from an account user (e.g., a push notification sent over a network and displayed on a graphical user interface of the account user computing device).

At block 1626, the system may receive from the account user an acceptance of the counter-proposed transaction restriction parameter. Alternatively, as shown at block 1628, the system may receive from the account user a denial of the counter-proposed transaction restriction parameter. In some embodiments, in response to receiving the same, the system may simply cancel the update request at block 1620 in the same manner as if the account holder had denied the initial update request outright.

In the same way that it allows for an unlimited number of negotiating rounds between multiple account holders, the system may also allow for an unlimited number of negotiating rounds between an account holder and an account user. Alternatively, it may only allow for a limited number established by an account holder using configurable tools displayed on the graphical user interface of the account holder computing device. In other embodiments, the system may not allow for any negotiating.

At block 1630, the system may receive from an account user a request to create or update a transaction restriction parameter for an account associated with multiple account holders. As shown at block 1632, when the system determines that the account is associated with at least a second account holder, the system may require that all authorized account holders concur in any update to a transaction restriction parameter requested by an account user. In such embodiments, creating or updating the transaction restriction parameter may include additional steps compared to when only one account holder is associated with the account. For example, in some embodiments, upon determining that the account is associated with a second account holder, the system may send to both the first and second account holders a request to approve the update request received from the account user. At block 1632, in embodiments requiring concurrence among account holders, the system may include the negotiation and counter-proposal functionalities discussed above with respect to blocks 216 through 222 of FIG. 2.

Notably, in some embodiments, the system may not require all account holders to concur. Rather, the number of account holders that must concur in approving an update request may be configurable by one or more account holders. For example, in some embodiments, the system may only require a majority concurrence among multiple account holders.

Once the system has received any required concurrence among multiple account holders, at block cluster 1636 the system may proceed in the same manner described above with respect to blocks 1616 through 1628. At block cluster 1638, the system may satisfy the update request accessing the server and storing in memory the requested new or updated transaction restriction parameter. Block cluster 1638 may proceed in the same manner as described above with respect to blocks 224 through 246 of FIG. 2.

### Account Linking

Referring back to FIG. 1, as previously mentioned, system 100 may include functionality allowing multiple account holders authorized on a single account to restrict the scope of permissible transactions associated with the account. The functionality of system 100 is not limited, however, to dealing with a single account. On the contrary, system 100 may further include functionalities that allow multiple accounts to be linked for the use of a single account user.

System 100 may perform a method for linking multiple accounts. The linked accounts may individually be subject to one or more transaction restriction parameters as discussed above or, in embodiments in which the account link is created by establishing a third account associated with each of the accounts linked together, the third account may be subject to the one or more transaction restriction parameters. Like the transaction restriction parameters discussed above, an account link may be edited on any appropriate computing device that is communicatively coupled to system 100, such as a computer, smartphone, ATM, or kiosk. Persons of ordinary skill in the art will readily recognize that there are a vast number of computing devices suitable for implementing and interacting with the systems disclosed herein.

System 100 of FIG. 1 may allow account holders to link any number of accounts together and share funds between the multiple accounts based on configurable link parameters. For instance, one exemplary link parameter may be a set of fixed transaction percentages to be pulled from each linked account. Some link parameters may be related to transaction restriction parameters. In some embodiments, account holders may designate a hierarchy among the linked accounts. For example, where two accounts are linked, the account holder may designate one account a primary account and the other a secondary or “slave” account. The primary account may further be designated as the account from which the system will make withdrawals necessary to cover rounding errors. All other linked accounts may act as slave accounts to pay for agreed percentages or items within a requested transaction. Although this scenario describes pre-determined restrictions and linkages, it should be understood that changes may be made at any point in time to the accounts involved by the approved parties. Transaction restriction parameters and account links may be configured and implemented from any number of suitable computing devices and may be stored on either a service or other suitable computing device, such as a financial institution server or secure third party server.

In some embodiments, system 100 illustrate in FIG. 1 may function as an account linking system, either in conjunction with the previously described transaction authorization control system or as a stand-alone system. In such embodiments, system 100 may include a server 110 communicatively coupled by a network 120 to a computing device 130 associated with a first account holder.

Server 110 may be a financial institution server as labeled in FIG. 1, or it may be a payment service provider server or other third-party server. In some embodiments, system 100 may include a payment service provider server 140 in addition to server 110. Although not shown in FIG. 1, server 110 may include a processor and executable instructions stored in memory. System 100 may further include or interact with a point of sale device 150, such as a point of sale terminal or a server hosting a webpage that receives payment information.

Server 110 may receive a request from the first account holder to access a first account associated with the first account holder. The request for access may include a variety of login credentials, including a user name, password, security question, or any number of other login credentials that are known in the art and readily recognizable by persons of ordinary skill in the art.

Upon receiving the request from the first account holder, execution of the instructions by the processor may cause server 110 to grant the first account holder access to the first account based on the login credentials. Server 110 may grant access to the first account holder using any number of well-known login credential verification processes known in the art. In an effort to keep the present disclosure focused and concise, a detailed discussion of the many suitable login verification processes has been omitted. However, persons of ordinary skill in the art will readily appreciate such processes and their applicability to the systems and methods disclosed herein.

Server 110 may store in memory a plurality of account data associated with one or more accounts. In some embodiments, different portions of the account data may respectively correspond to both the first and a second account to which the first account is linked. Server 110 may receive the account data from a computing device operating within system 100, or it may receive the account data from a third-party computing device operating external to but communicatively coupled with system 100, such as a third-party server. In some embodiments, server 110 may store the account data in database 160. In some embodiments, database 160 may be stored in memory of server 110, while in other embodiments database 160 may be maintained in one or more separate servers communicatively coupled to server 110 by network 120. The account data may be stored in one or more tables associated with the first account. The tables may be stored in previously described database 160, or they may be stored in any other suitable data structure, several of which will be readily apparent to persons of ordinary skill in the art.

The account data may include one or more link parameters associated with the first account belonging to the first account holder. In some embodiments, the link parameters may be stored independent of other account data. A link parameter may govern how system 100 releases funds maintained in the first account after system 100 has approved a transaction request. By default, a link parameter field stored in memory may be an empty or zero data field, or it may contain default logic that does not execute absent the addition of further input from an account holder requesting the creation of a link parameter. Alternatively, in some embodiments, every account managed by system 100 may by default contain a link parameter that governs what percentage of a requested transaction should be withdrawn from the account to satisfy the amount owed according to the transaction details after the transaction request has been approved. In such embodiments, this default “transaction contribution percentage” link parameter may be set to 100% such that in the absence of a link with a second account, the first account always pays 100% of any amount owed for an approved transaction.

Server 110 may receive from the first account holder a request to create an account link with a second account holder associated with a second account. In some embodiments, receiving from the first account holder the request to create an account link with the second account holder associated with the second account may include receiving a request to create or update a link parameter stored in memory. As noted above, the link parameter may govern the manner in which funds are to be withdrawn from the first and second accounts in response to the approval of a transaction request.

In response to receiving the request from the first account holder, server 110 may create an account link between the first account associated with the first account holder and the second account associated with the second account holder. Creating the account link may include creating or updating a link parameter associated with each respective account such that an approved transaction will only be successfully paid in full when funds are drawn against both accounts according to their respective link parameters. Creating the account link may include storing the new or updated link parameter in memory. The account data associated with each account respective account may contain pointers to any other accounts to which it is linked. Accordingly, when a transaction request associated with the first account is approved, server 110 may check for any applicable link parameters that require additional funds be withdrawn from the linked second account in order to fully satisfy the amount due in accordance with the approved transaction.

By way of example, Account Holder may be associated with Account A and Account B. Server 110 may receive a request from Account Holder to create an account link between Accounts A and B. The request from Account Holder may include a request to create or update a “transaction contribution percentage” link parameter associated with each account. Account Holder may desire that 10% of any transaction amount approved by system 100 be satisfied from funds or credit in Account A, while 90% of the transaction amount be satisfied using funds or credit in Account B. In such a case, Account Holder may use a graphical user interface to request that server 110 update the transaction contribution percentage link parameter associated with Account A such that 10% of any transaction amount approved by system 100 be satisfied from funds or credit in Account A. Account Holder may likewise use the graphical user interface to request that server 110 update the transaction contribution percentage link parameter associated with Account B such that 90% of the transaction amount be satisfied using funds or credit in Account B. Server 110 may approve a transaction request for $100. The transaction may have been requested in response to Account Holder swiping a debit card associated with Account A. In response to receiving the transaction request for $100, server 110 may compare the transaction details to the account data associated with Account A. Comparing the transaction details to the account data may include comparing the amount necessary to satisfy the transaction to the transaction contribution percentage link parameter associated with Account A.

In such scenario, according to one embodiment of system 100, server 110 would read the transaction contribution percentage link parameter and recognize that server 110 may only withdraw 90% of the total $100 transaction amount from Account A. Server 110 would read the pointer to Account B, which may be stored in the account details either independently or within a link parameter, and then read the account details associated with Account B. Upon reading the account details associated with Account B, server 110 would read the transaction contribution percentage link parameter and confirm that server 110 may withdraw the remaining 10% of the total $100 transaction amount from Account B in accordance with the link parameter governing the account link between Accounts A and B. Server 110 would then proceed in authorizing payment of the $100 amount due by withdrawing $90 from Account A and $10 from Account B.

In some embodiments, creating an account link between the first account associated with the first account holder and the second account associated with the second account holder may include creating a third account associated with both the first account and the second account and governed by the link parameter. In such embodiments, any request transaction may be processed through the intermediary third account. The use of an intermediary third account may allow an authorized account user, which in some instances may be the same or a different person or entity as the account holder, to utilize a transaction request mechanism such as a debit card, credit card, check, and the like, that is distinct from either the first or second accounts. In such cases, the third account may be associated with collective link parameters that reflect the respective link parameters associated with the first and second accounts.

Creating an account link between the first account associated with the first account holder and the second account associated with the second account holder may also include scheduling a one-time transfer between the first account and the second account based on the link parameter. In some instances, an account holder may wish to link the first and second accounts for a temporary, one-time transaction. In such cases, creation of a lasting third account may not be necessary. Rather, upon receiving a request to approval a transaction, server 110 may read a link parameter associated with the first account that directs server 110 to read a link parameter associated with the second account. The link parameter associated with the second account may direct server 110 to make a one-time transfer to the first account according to a certain percentage, amount, or other variable defined by the link parameter.

As discussed further below, the link parameter may include a variety of configurable parameters that server 110 analyzes to determine how to fulfill an approved transaction. Multiple link parameters may be used jointly. An account holder may use the link parameters to tailor the account link to suit his or her needs. Exemplary link parameters may include parameters governing transaction contribution percentages or parameters specifying certain conditions upon which an account link is made in the first place. For example, system 100 may include a repayment condition link parameter. The repayment condition link parameter may require that one or more account holders accept a specified repayment condition before system 100 will create the account link between the respective accounts associated with the account holders. The repayment condition may be that, in return for the first account holder agreeing to link accounts with the second account holder, the second holder promises to repay some or all funds or credit used from the account associated with first account holder. The repayment condition may require repayment on a periodic basis, or it may require repayment as a lump sum. For example, as shown in linking requests pane 618 of FIG. 6, a second account holder named User X has agreed to provide $212.35 towards the purchase of an item subject to a repayment condition requiring the first account holder to pay User X $25.00 by the 15th of every month for the next nine months.

Other exemplary link parameters may include conditions related to ownership. For example, a first account holder could condition accepting the link upon the second account holder agreeing that an item purchased will belong to the second account holder for a period of time before permanently becoming the property of the first account holder. For instance, two roommates may link their respective checking accounts for the purpose of executing a one-time transaction to buy a television for their apartment. The first roommate may agree to contribute more funds to the link than the second roommate subject to a link parameter that includes a condition stating that upon moving the television becomes the exclusive property of the first roommate. System 100 may allow account holders to customize such condition-based link parameters. System 100 may further transmit records of custom conditions to one or more parties involved for purposes of complying with contract law. In the above example, after the roommates approve the link request, system 100 may e-mail or text both of them a copy of the agreed-upon condition for their future reference in the event of a dispute.

Server 110 may receive from the first account holder a request to store a new or updated link parameter in memory. In response, server 110 may store the new or updated link parameter in accordance with the update request. In some embodiments, updating the link parameter may include two sub-steps wherein the server first confirms that the account is not associated with a second account holder before updating the link parameter based on the update request received from the first account holder.

In some situations, an account may be associated with more than one authorized account holder. For example, where a husband and wife share a joint checking or credit account, both parties may have access to the account. In some embodiments, system 100 may require that all authorized account holders concur in any creation of or update to a link parameter requested by any individual account holder. In such embodiments, updating the link parameter may include other sub-steps, including determining that the account is associated with a second account holder. Upon determining that the account is associated with a second account holder, server 110 may send to the second account holder a request to approve the update request received from the first account holder. Server 110 may further receive from the second account holder a response to the approval request. Server 110 may then store a new or updated link parameter based on the update request received from the first account holder when the response to the approval request received from the second account holder is an approval.

System 100 may further enable multiple account holders to negotiate an agreed upon link parameter update using one or more counter-proposed updates. In such embodiments, updating the link parameter may include determining that the account is associated with a second account holder and sending to the second account holder a request to approve the update request received from the first account holder. In response to the approval request sent to the second account holder, server 110 may receive from the second account holder a response to the approval request. In some embodiments, the response received from the second account holder may be a counter-proposed update. In such embodiments, upon receiving from the second account holder a counter-proposed update, server 110 may send to the first account holder a request to accept the counter-proposed update received from the second account holder. Server 110 may further receive from the first account holder a response to the acceptance request. Server 110 may update the link parameter based on the counter-proposed update received from the second account holder when the response received from the first account holder to the acceptance request is an acceptance.

In some embodiments, system 100 may allow even further negotiations between the first and second account holders. For example, rather than an acceptance, the response from the first account holder to the acceptance request may be a further counter-proposed update. In such cases, server 110 may receive the counter-proposed update from the first account holder and send to the second account holder a request to accept the further counter-proposed update received from the first account holder. Server 110 may further receive from the second account holder a response to the request to accept the further counter-proposed update. Server 110 may then update the link parameter based on the further counter-proposed update received from the first account holder when the response received from the second account holder to the request to accept the further counter-proposed update is an acceptance.

In some instances, the multiple account holders may not be able to negotiate an agreed upon new or updated link parameter at issue. For example, in the aforementioned scenario, rather than accepting the counter-proposed update proposed by the first account holder, the second account holder may simply wish to end the negotiations by flatly denying the request. In such instances, server 110 may send to the first account holder a notification that the second account holder denied the approval request when the response to the approval request received from the second account holder by server 110 is a denial. Server 110 may then deny the update request received from the first account holder, at which point the first account may begin the process over again by proposing a subsequent link parameter, which may be same link parameter as negotiated over previously or some other link parameter that the first account holder believes may be better received by the second account holder.

Once a link parameter is updated, system 100 may use the link parameter when processing a requested transaction. Server 110 may receive a transaction request. The transaction request may include a plurality of transaction details. The transaction request may have been sent by a merchant server, a payment service provider server, or some other third-party intermediary server. In response to receiving the transaction request, server 110 may execute instructions stored in memory. In some embodiments, execution of the instructions by the server processor may cause server 110 to compare the transaction details to the link parameter. Server 110 may then approve and satisfy the transaction request according to any applicable link parameters associated with either the individual accounts linked together, or where applicable, to a distinct third account subject to the link parameters. Before approving the transaction request, server 110 may also first confirm that the transaction details do not violate any transaction restriction parameters associated with one or more of the linked accounts. Server 110 may decline the transaction request when the transaction details violate the updated transaction restriction parameter.

System 100 may further include an account user computing device 170. Account user computing device 170 may be communicatively coupled to server 110 by network 120. Account user computing device 130 may be a desktop computer, laptop computer, tablet, netbook, smartphone (e.g., an iPhone produced by Apple Inc. of Cupertino, Calif.), or any other suitable computing device known in the art. The account user computing device 170 may have an application stored in memory that, when executed by a processor of account user computing device 170, causes the application to display a graphical user interface associated with system 100. An exemplary graphical user interface is displayed at FIG. 4. Using the graphical user interface displayed on account user computing device 170, the account user may communicate with system 100 to carry out the various functionalities described herein. In some cases, the account holder may be the same person or entity as the account user. However, in other cases the account holder may be distinct from the account user. In such cases, system 100 may serve as an intermediary between the account user and the account holder in the same manner described above with respect to multiple account holders.

FIG. 17 is a block diagram further illustrating the operation of an exemplary account linking system 1700. At block 1702, an account holder may access an account using a graphical user interface displayed on an account holder computing device. Using a network, the system may provide the account holder computing device with the data and instructions necessary to render and display the graphical user interface. As discussed above, the account holder may access the account by logging in using pre-established login credentials and any number of suitable login verification methods known in the art.

As shown at block 1704, when the account holder accesses the account, a server or other capable computing device is accessed. For example, a financial institution server may be accessed. In some embodiments, the financial institution server may include a database stored in memory. As previously discussed, the database may contain various transaction restriction parameters and other information associated with the account.

At block 1706, the account holder may create or update a link associated with the account by communicating with the system via the graphical user interface displayed on the account holder computing device. The account user may link multiple accounts communicating with the system via the graphical user interface displayed on the account holder computing device. At block 1708, the system may determine whether the account is associated with a single authorized account holder or multiple authorized account holders.

At block 1710, when the system determines that the account is associated with a single authorized account holder, the system may receive and approve any new or updated links created by the sole account holder. The account holder may do so by communicating with the system via the graphical user interface displayed on the account holder computing device. As discussed further in more detail, the account may further specify a primary account and one or more slave accounts at block 1710. In embodiments in which the account linking and transaction authorization control functionalities described herein are employed within a single system, an account holder may further create or update transaction restriction parameters at block 1710.

At block 1712, the system may receive a request to create or update a link from one of multiple account holders associated with an account. As shown at block 1714, when the system determines that the account is associated with at least a second account holder, the system may require that all authorized account holders concur in any update to a link requested by any individual account holder. In such embodiments, creating or updating the link may include additional steps compared to when only one account holder is associated with the account. For example, in some embodiments, upon determining that the account is associated with a second account holder, the system may send to the second account holder a request to approve the link request received from the first account holder. In embodiments in which the account linking and transaction authorization control functionalities described herein are employed within a single system, the system may send an approval request regarding any new or updated transaction restriction parameters at the same time it sends the approval request regarding the new or updated account link.

As shown at blocks 1716 and 1718, the second account holder may wish to outright deny the link proposed by the first account holder. In such cases, in response to receiving a denial response from the second account holder, the system may cancel the proposed link and notify the first account holder that the second account holder refused to concur.

As shown at block 1720, however, in some cases the second account holder may wish to counter-propose a link. In such cases, the system may receive a counter-proposed link from the second account holder. The system may then cycle back to block 1714 and send a request to the first account holder to approve the counter-proposed link. The system may allow for an unlimited number of negotiating rounds, or it may only allow for a limited number set by one or more of the account holders. In other embodiments, the system may not allow for any negotiating based on input received from one or more of the account holders. As shown at block 1722, in some instances the second account may simply wish to approve the link request received from the first account holder and relayed to the second account holder by the system.

At block 1724, the system may create or update an account link by accessing the server or other computing device having the link parameters stored in memory. In some embodiments, as shown at block 1724, the link parameters may be stored in one or more databases. The database may further store the link parameters in one or more tables as shown at block 1726.

At block 1728, the system may issue a new card or account number to an authorized account user associated with the account. In some cases, multiple account users may be associated with a single account. In such cases, the system may issue a new card or account number to some or all of the multiple account users. In some embodiments, the system may not issue a new card or account number, but rather allow the account user to continue using the same card and account number that the account user was using prior to the update.

At block 1730, the account user may attempt to execute a transaction using funds located in the account managed by the system. The account may be associated with any number of transaction devices known in the art, such as credit cards, debit cards, traditional checks, electronic checks, electronic fund transfers, and the like. For example, as shown at block 1730, the account user may present to a merchant at a point of sale a credit card associated with an account managed by the system.

At block 1732, the account and transaction details may be sent from the point of sale to a server associated with the merchant. The server associated with the merchant may then deliver the transaction details to the system and request authorization to proceed with the proposed transaction. As noted above, the system may include a server or other suitable computing device. For example, the system may include a financial institution server. In some embodiments, like that shown in FIG. 17, the server may include a database stored in memory and the database may include one or more tables for storing data. The database may contain various link parameters, including the new or updated link parameters stored in memory at blocks 1726, and other account data associated with the account, any of which may be stored in one or more of the tables.

At block 1734, the system may receive the transaction request from the server associated with the merchant. The transaction request may include a plurality of transaction details. The system may receive the transaction request directly from a merchant server, or from an intermediary computing device such as a payment service provider server or some other third-party server.

At block 1736, in response to receiving the transaction request, the system may execute instructions stored in memory. Execution of the instructions may cause the system to compare the transaction details to one or more link parameters stored in memory and associated with the account specified in the transaction details. For example, as shown at block 1736, the system may read the tables containing the new or updated link parameters stored in memory at block 1726. The system may then compare the transaction details to the link parameters. In doing so, system may determine if and how to satisfy the amount due according to the transaction details.

At block 1738, the system may credit a merchant account or otherwise execute the requested transaction according to the transaction details using funds or credit adjusted according to the link parameters. For example, where the system reads a transaction contribution percentage link parameter associated with a first and second account that are linked to one another, the system may execute the transaction by withdrawing a certain percentage from each account as specified by the link parameter.

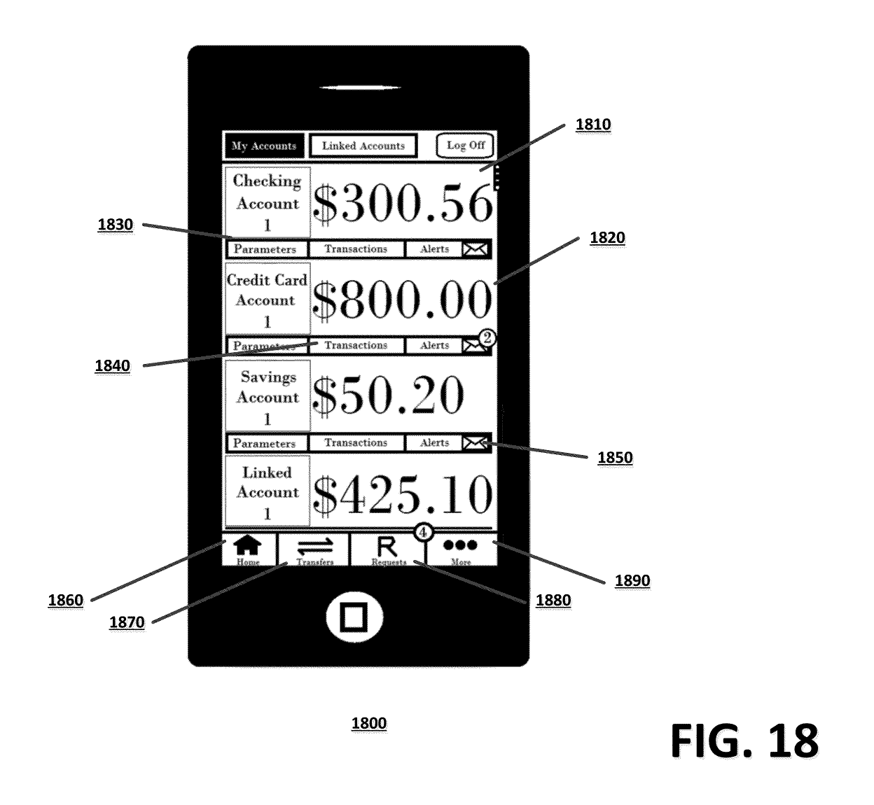

FIGS. 18 through 24 illustrate various exemplary graphical user interfaces that may displayed on an account holder computing device and used to interact with various functionalities of the system disclosed herein.

FIG. 18 illustrates another exemplary graphical user interface that may displayed on an account holder computing device and used to interact with various functionalities of the system disclosed herein. A mobile application may be installed upon an account holder computing device. The mobile application may include instructions that, when executed, cause the account holder computing device to render and display graphical user interface 1800 to the account holder. Graphical user interface 1800 may contain a number of display windows through which the system may communicate information to an account holder. Graphical user interface 1800 may be integrated into or may work in conjunction with a graphical user interface associated with financial institution account management tools. Graphical user interface 1800 may include an account overview page 1810. Account overview page 1810 may include an account list 1820. Account list 1820 may display one or more accounts associated with an account holder. Graphical user interface 1800 may contain a number of selectable buttons through which an account holder may communicate with the system. For example, graphical user interface 1800 may contain a “restrictions” button 1830, a “transaction” button 1840, an “alerts” button 1850, a “home” button 1860, a “transfers” button 1870, a “requests” button 1880, or a “more” button 1890. In some embodiments, some of the selectable buttons may direct the account holder to other graphical user interfaces related to communicating with other systems that may be related to or entirely separate from the system and methods disclosed herein. For example, the foregoing may be particularly likely where graphical user interface 1800 is integrated into or works in conjunction with a broader financial institution account management system.

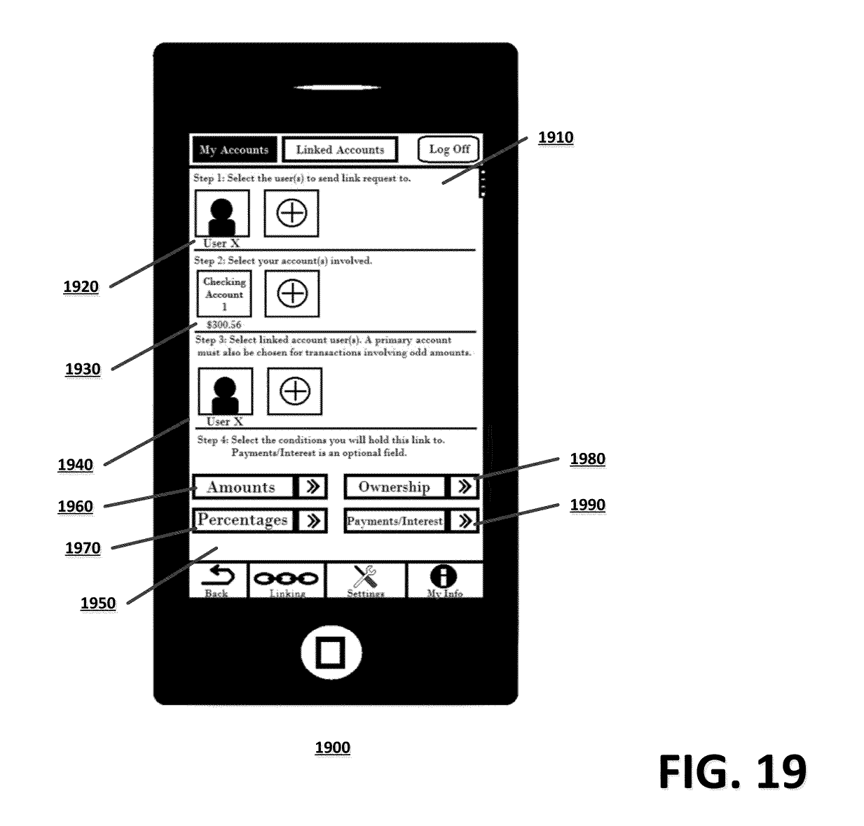

An account holder may use the exemplary graphical user interface of FIG. 18 to interact with the account linking functionalities of the system disclosed herein. The account holder may select “more” button 1890, which may in turn cause the system to display a number of additional buttons. One such button may be a “linking” button as shown and later described in FIG. 19. Upon selection of the linking button by the account holder, the system may display a further graphical user interface like that shown in FIG. 19.

FIG. 19 illustrates another exemplary graphical user interface that may displayed on an account holder computing device and used to interact with various functionalities of the system disclosed herein. Upon selection by the account holder of the “linking” button described with respect to FIG. 18, the system may display a further graphical user interface that permits the account holder to create or update an account link by requesting that the system store a new or updated link parameter in memory. For example, the system may display graphical user interface 1900. Graphical user interface 1900 may include a link creation window 1910. Link creation window 1910 may include textual and/or graphical instructions guiding the account user through the link creation process. For example, as shown in FIG. 19, link creation window 1910 may display a user selection pane 1920.

User selection pane 1920 may include instructions to the account holder and one or more configurable or selectable fields and/or tools for notifying the system as to with which additional account holders and/or account users the account holder wishes to create an account link. As shown in FIG. 19, the account holder has configured the input tool to instruct the system to create an account link with User X. In this example, the account holder wishes to create an account link with a second account holder. As noted above, however, an account holder can also create an account link between multiple accounts all belonging to that same account holder. In such a case, the account holder would have identified him or herself rather than User X.

Link creation window 1910 may further display an account selection pane 1930. Account selection pane 1930 may include instructions to the account holder and one or more configurable or selectable fields and/or tools for instructing the system as to which account or accounts belonging to the account holder the system should use to create the link. As shown in FIG. 19, the account holder has configured the input tool to instruct the system to create an account link using Checking Account 1, which contains a balance of $300.56.

Link creation window 1910 may further display an authorized account user selection pane 1940. Authorized account user selection pane 1940 may include instructions to the account holder and one or more configurable or selectable fields and/or tools for instructing the system as to which person or persons the system should recognize as an authorized account user of the linked account. As shown in FIG. 19, the account holder has configured the input tool to instruct the system recognize User X as an authorized user of the linked account. using Checking Account 1, which contains a balance of $300.56.

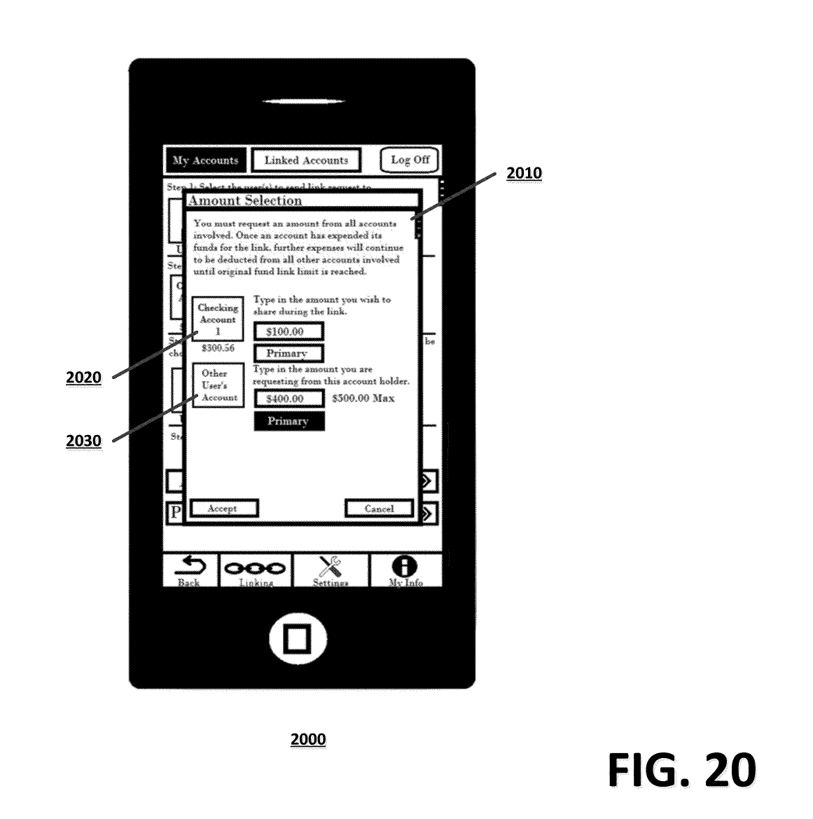

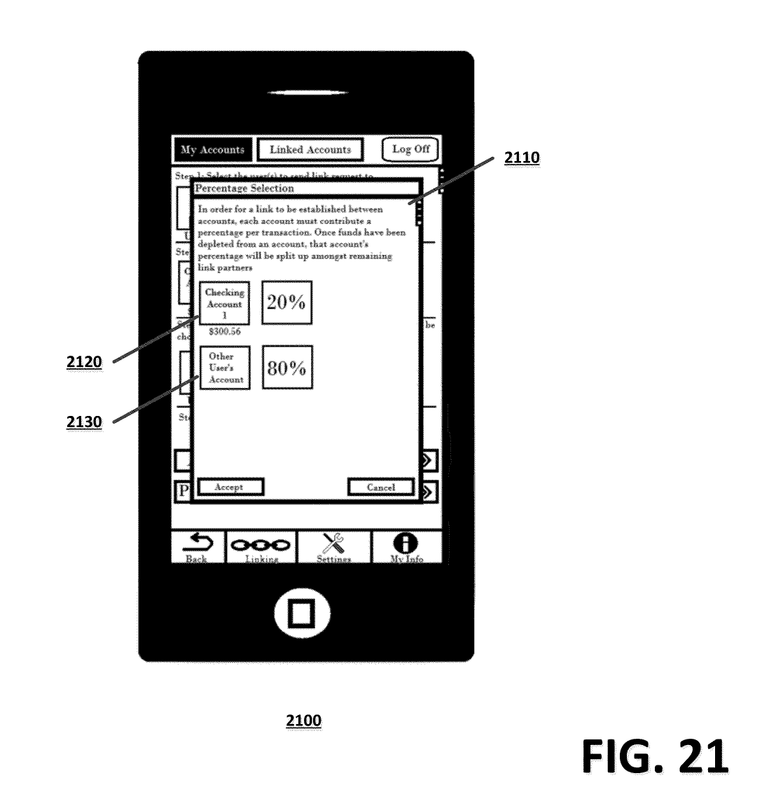

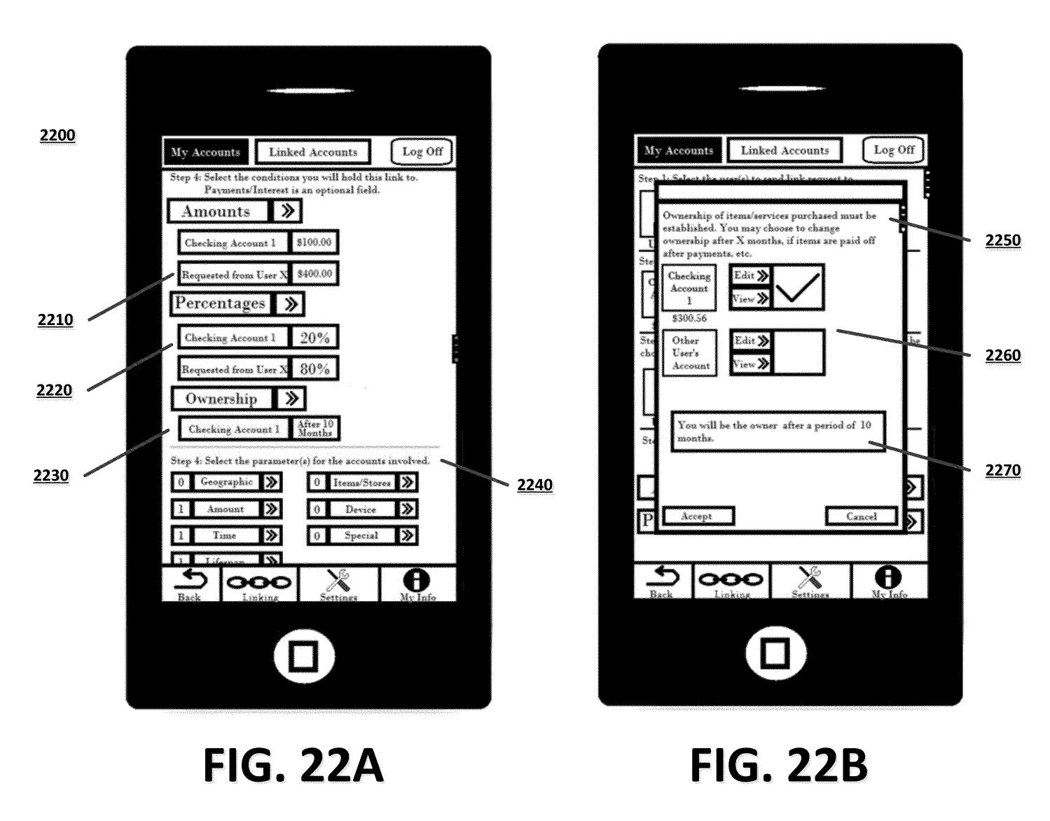

Link creation window 1910 may further include a link parameter configuration pane 1950. Link parameter configuration pane 1950 may include instructions to the account holder and one or more configurable or selectable fields and/or tools for instructing the system as to which link parameters should govern the linked account. For example, as shown in FIG. 19, link parameter configuration pane 1950 may include an “amounts” link parameter button 1960 that relates to governing the total amount of funds or credit to be linked and a “percentages” link parameter button 1970 that relates to governing the percentage of any approved transaction that should be satisfied using funds or credit from each of the accounts to be linked. Link parameter configuration pane 1950 may further include an “ownership” link parameter button 1980 that relates to governing which account holder(s) will own a particular good or service that is purchased with linked credit or funds. Link parameter configuration pane 1950 may further include a “payments/interest” link parameter button 1980 that relates to governing repayment conditions that may have been established between account holders. Upon selection of the “amounts” link parameter button 1960 by the account holder, the system may display via a graphical user interface like that shown in FIG. 20 an additional window containing one or more editable fields and/or selectable tools for transmitting instructions to the system as to the fund or credit amount each account being linked will provide towards the linked account. Upon selection of the “percentages” link parameter button 1970 by the account holder, the system may display via a graphical user interface like that shown in FIG. 21 an additional window containing one or more editable fields and/or selectable tools for transmitting instructions to the system as to the percentage of any approved transaction that should be satisfied using funds or credit from each of the accounts to be linked. Upon selection of the “ownership” link parameter button 1980 by the account holder, the system may display via a graphical user interface like that shown in FIG. 22B an additional window containing one or more editable fields and/or selectable tools for transmitting instructions to the system as to any conditions surrounding ownership of an item or service purchased using funds or credit in the linked account.

Link creation window 1910 may further include, either within or separate from link parameter configuration pane 1950, one or more configurable or selectable fields and/or tools for instructing the system as to which account should be used as the primary or “master” account and which account should be used as the secondary or “slave” account. In some embodiments, the designation of master and slave accounts may be implemented as an “account relationship” link parameter and grouped in with any number of other link parameters. As discussed previously, the system may configured such that funds or credit from either the master or slave account are exclusively used to satisfy any rounding issues that arise when fulfilling an approved transaction.

FIG. 20 illustrates another exemplary graphical user interface that may displayed on an account holder computing device and used to interact with various functionalities of the system disclosed herein. Upon selection of the “amounts” link parameter button 1960 of FIG. 19 by the account holder, the system may display graphical user interface 2000. Graphical user interface 2000 may include an “amount selection” window 2010 containing one or more editable fields and/or selectable tools for transmitting instructions to the system as to the fund or credit amount each account being linked will provide towards the linked account. For example as shown in FIG. 20, amount selection window 2010 may include an amount contributed field 2020 and an amount requested field 2030. At amount contributed field 2020, the system may receive from the account holder an instruction as to how much funds or credit from a first account should be used to create the linked account. At amount requested field 2030, the system may receive from the account holder an instruction as to how much funds or credit from a second account should be used to create the linked account.

In some embodiments, the system may require that an amount be provided for each account to be linked. In other embodiments, the system may allow an amount to be specified for only some accounts, while the unspecified amounts the remaining accounts are set to zero. Further, in embodiments once an account has expended its funds specified under the amounts link parameter, the system may continue to use funds or credit from all remaining accounts within the linked account until the total amount contributed to the account link is reached. The system may further allow an account holder to set a limit on an account that prevents the system from linking a higher fund or credit amount than the account holder desires. For instance, where an account holder is linking a checking account with a $500 balance, the account holder may limit the system from withdrawing more than $500 from the account, an event that could otherwise cause the account holder to experience an overdraft fee.

FIG. 21 illustrates another exemplary graphical user interface that may displayed on an account holder computing device and used to interact with various functionalities of the system disclosed herein. Upon selection of the “percentages” link parameter button 1970 of FIG. 19 by the account holder, the system may display via a graphical user interface 2100. Graphical user interface 2100 may include a “percentages selection” window 2110 containing one or more editable fields and/or selectable tools for transmitting instructions to the system as to the percentage of any approved transaction that should be satisfied using funds or credit from each of the accounts to be linked.

For example as shown in FIG. 21, percentages selection window 2110 may include a percentage contributed field 2120 and a percentage requested field 2130. At percentage contributed field 2120, the system may receive from the account holder an instruction as to the percentage of any approved transaction that should be satisfied using funds or credit from a first account to be linked. At percentage requested field 2130, the system may receive from the account holder an instruction as to the percentage of any approved transaction that should be satisfied using funds or credit from a second account to be linked.

In some embodiments, once a particular account has been depleted of all available linked funds or credit, the system may automatically update the percentages link parameter such that any further approved transactions are satisfied equally by all remaining linked accounts having sufficient funds. In some embodiments, the conditional update to the percentage link parameter may be selectable by the account holder using additional configurable or selectable fields and/or tools displayed via graphical user interface 2100. In some embodiments, the system may permit an account holder to leave a percentage field blank for a particular account to be linked, in which case the system use all necessary funds or credit from a first account designated as the primary or “master” account until all of the linked funds or credit therein have been depleted. After all linked funds or credit in the “master” account have been depleted, the system may then use funds or credit residing in a second account designated as the “slave” account.

FIG. 22A illustrates another exemplary graphical user interface that may displayed on an account holder computing device and used to interact with various functionalities of the system disclosed herein. As shown in FIG. 22A, in some embodiments graphical user interface 1900 of FIG. 19 may contain additional configurable or selectable fields and/or tools through which the system may receive instructions from an account holder. Graphical user interface 2200 shows an exemplary version of such an interface. Upon selection of the “amounts” link parameter button 1960 of FIG. 19 by the account holder, the system may display additional sub-fields or sub-tools 2210 for configuring the amount link parameter. Upon selection of the “percentages” link parameter button 1970 of FIG. 19 by the account holder, the system may display additional sub-fields or sub-tools 2220 for configuring the percentages link parameter. Upon selection of the “ownership” link parameter button 1980 of FIG. 19, the system may display addition sub-fields or sub-tools 2230 for configuring the ownership link parameter. Graphical user interface 2200 may further include a transaction restriction parameters configuration window 2230. Through the various configurable or selectable fields and/or tools contained in transaction restriction parameters configuration window 2240, the system may receive a request from the account holder to store a new or updated transaction restriction parameter in memory. The transaction restriction parameter may apply to one or more of the accounts being linked, or it may apply to the collective linked account. In some embodiments, the account holder who initiates the link parameter update request may be responsible for configuring any transaction restriction parameters that will govern the linked account.

FIG. 22B illustrates another exemplary graphical user interface that may displayed on an account holder computing device and used to interact with various functionalities of the system disclosed herein. As shown in FIG. 22B, in some embodiments, selection of one or more of the above-described selectable buttons related to condition or ownership link parameters may cause the system display an additional ownership configuration window 2250. Ownership configuration window 2250 may include one or more editable fields or configurable tools 2260 and 2270 for identifying which of the account holder(s) associated with the linked account will take ownership of the good or service if the holders desire for a single party to wholly own the good or service after a specified period of time. Upon receiving such data from an account holder, the system may store the data in memory as a new or updated link parameter.

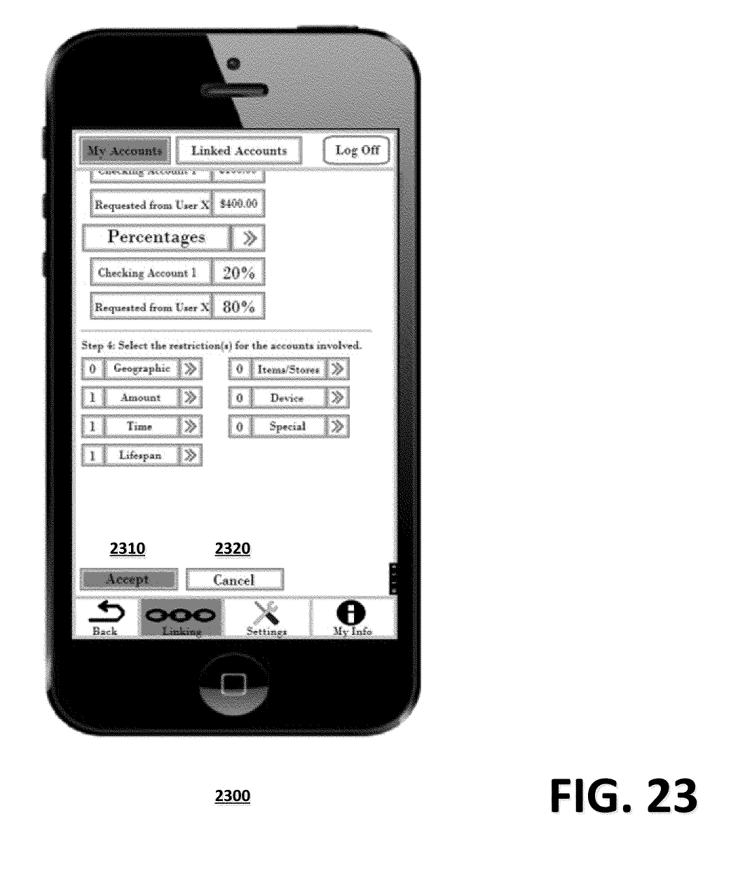

FIG. 23 illustrates another exemplary graphical user interface that may displayed on an account holder computing device and used to interact with various functionalities of the system disclosed herein. In addition to the elements described above, graphical user interface 2300 may include an “accept” button 2310 and a “cancel” button 2320. Upon selection of the accept button 2310 by the account holder, the system may process the request to store a new or updated link parameter in memory. The system may further automatically send out any notifications to the one or more account holders involved. The system may transmit such messages via phone, text message, push notification, e-mail, or any other suitable form of electronic communication.

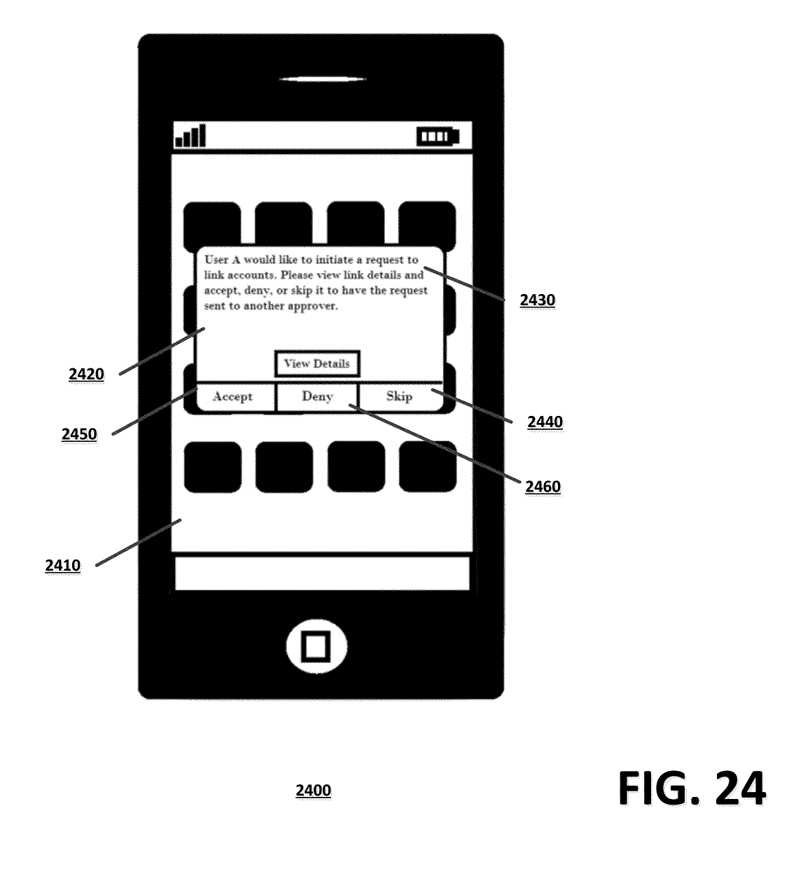

FIG. 24 illustrates another exemplary graphical user interface that may displayed on an account holder computing device and used to interact with various functionalities of the system disclosed herein. Graphical user interface 2400 may be used to communicate notifications and link parameter update requests to an account holder similar to the way in which graphical user interface 1100 of FIG. 11 may do so with respect to suggesting transaction restriction parameter updates.

The system may communicate notifications and update requests to an account holder in a variety of ways. For example, as shown in FIG. 24, the account holder computing device may be a smartphone, tablet computer, or other mobile computing device and the system may send a “push notification” to the account holder computing device. Graphical user interface 2400 may include a main display region 2410. The push notification may appear as a notification window 2420 within main display region 2410 of graphical user interface 2400. Notification window 2420 may include a notification 2430. Notification 2430 may include a text-based explanation regarding a link parameter update requested by an account holder. For example, as shown in FIG. 24, notification 2430 informs the account holder that “Account Holder A would like to create a linked account with you. They are requesting $400.00 and they will be the primary account user. You will be prompted to choose the account for this link once you accept the restrictions.”

Notification window 2420 may further include a “view details” button 2440 that, when selected by the account holder, allows the account holder to view additional details regarding the link parameter update request. Notification window 2420 may further include an “accept” button 2450. When accept button 1150 is selected by the account holder, the system may receive an approval response from the account holder computing device. Notification window 2420 may further include a “deny” button 2460. When deny button 2460 is selected by the account holder, the system may receive a denial response from the account holder computing device.

In some embodiments, notification window 2420 may further include a “skip” button like that shown in FIG. 11. The skip button may be displayed when a single account is associated with more than one account holder or with an account holder and a third-party reviewer. In such cases, the system may allow a first account holder to defer to the decision of a second account holder by passing the request along to the second account holder or the third-party reviewer.

### Account Holder-Account User Negotiated Link Parameters

FIG. 25 is a block diagram that illustrates the operation of an exemplary account linking system. At block 2502, an account user may access an account using a graphical user interface displayed on an account user computing device. The system may provide the account user computing device with the data and instructions necessary to render and display the graphical user interface. Such data and instructions may be downloaded as an executable application, such as a mobile application on a smartphone. The graphical user interface available to the account user may be similar to one or more of the exemplary graphical user interfaces shown and discussed herein with respect to the account holder. As discussed above, the account holder may access the account by logging in using pre-established login credentials and any number of suitable login verification methods known in the art.

As shown at block 2504, when the account holder accesses the account, a server or other capable computing device is accessed. For example, a financial institution server may be accessed. In some embodiments, the financial institution server may include a database stored in memory. As previously discussed, the database may contain a plurality of link parameters, transaction restriction parameters, and other data associated with the account.

At block 2506, as discussed above with reference to block 1606 of FIG. 16, graphical user interface on the account user computing device may display a limited subset of the information and tools displayed on the graphical user interface of an account holder user computing device. For example, an account user may only be able to view basic account information, and a list of applicable link parameters and/or transaction restriction parameters associated with the account.

At block 2508, in some embodiments, the graphical user interface of the account user computing device may contain a plurality of fields and other input tools for configuring a link parameter and/or transaction restriction parameter update request to be sent to the system and relayed to one or more authorized account holders for review and approval.

At block 2508, the server may receive from the account user a request to adjust or update a link parameter stored in memory and associated with the account that the account user desires to use. The server may communicate with the account user via the graphical user interface displayed on the account user computing device. For example, in some embodiments, the request may originate when the account user uses the graphical user interface displayed on the account user computing device to configure a request to store a new or updated link parameter in memory of the server and selects a “Send Request” button displayed thereon. The account user computing device, having been communicatively coupled to the server over a communications network, may then transmit the update request to the server. As previously discussed with reference to FIG. 16, the account user may also request adjustments to account transaction restriction parameters by communicating with the system via the graphical user interface displayed on the account user computing device.

At block 2510, the system may determine whether the account is associated with a single authorized account holder or multiple authorized account holders.

At block 2512, when the system determines that the account is associated with a single authorized account holder, the system may forward the update request to the sole account holder for review and approval.

At 2514, the account holder may review the update request on the graphical user interface displayed on the account holder computing device. As described above with respect to FIG. 11, the update may appear on the graphical user interface as a “push notification,” a text message, an e-mail, or any other suitable form of notification. Either before or after accepting the update request, the system may receive from the account holder a link parameter defining the relationship between the accounts to be linked. For example, where a first account is to be linked to a second account, the system may receive a link parameter defining the first account as the primary or “master” account and the second account as the secondary or “slave” account. Either the master or slave account may be designated as the account from which credit or funds should utilized to address any rounding issues or errors when the system satisfies an approved transaction with funds or credit from the linked accounts. In embodiments in which the account linking and transaction authorization control functionalities described herein are employed within a single system, an account holder may further create or update transaction restriction parameters at block 2514.

At 2516, the account holder may accept the update request sent by the account user. The account holder may do so by selecting an “Accept Request” or similar button displayed either within the user request itself or within a separate area of the graphical user interface displayed on the account user computing device. For example, as discussed with reference to FIG. 11, a notification window may include a “details” button that, when selected by the account holder, allows the account holder to view additional details regarding the update request. The notification window may further include an “accept” button. When accept button is selected by the account holder, the system may receive an approval response from the account holder computing device.

As discussed in detail with reference to FIG. 16, the system may receive from an account holder information sufficient to identify a third-party whom the account holder wishes to have the authority to accept or deny update requests. Notably, in addition to simply accepting or denying update requests, in some embodiments the third-party may also be able to configure transaction restriction or link parameters on the account holder's behalf.

At block 2518, the account holder may deny the update request sent by the account user. A graphical user interface identical or similar to that shown in FIG. 11 may be displayed on the account holder computing device. The notification window may include a “deny” button. When the deny button is selected by the account holder, the system may receive a denial response from the account holder computing device.

As shown at block 2518, the account holder may wish to outright deny the link parameter update proposed by the account user. In such cases, as shown at 2520, in response to receiving a denial response from the account holder, the system may cancel the proposed update and notify the account user that the account holder refused to approve the update request.

As shown at block 2522, however, in some cases the account holder may wish to counter-propose a link parameter update. In such cases, the system may receive a counter-proposed link parameter update from the account holder. The system may receive the counter-proposed link parameter through a number of configurable fields and tools displayed on the graphical user interface of the account holder computing device, many illustrative examples of which are shown throughout the figures and drawings disclosed herein.

At block 2524, the system may transmit the counter-proposed link parameter to the account user computing device. The system may notify the account user that he or she has received a counter-proposed link parameter much in the same way that the system may notify an account holder of a pending an update request from an account user (e.g., a push notification sent over a network and displayed on a graphical user interface of the account user computing device).

At block 2526, the system may receive from the account user an acceptance of the counter-proposed link parameter. Alternatively, as shown at block 2528, the system may receive from the account user a denial of the counter-proposed link parameter. In some embodiments, in response to receiving the same, the system may simply cancel the update request at block 2520 in the same manner as if the account holder had denied the initial update request outright.

In the same way that it allows for an unlimited number of link parameter-related negotiating rounds between multiple account holders, the system may also allow for an unlimited number of link parameter-related negotiating rounds between an account holder and an account user. Alternatively, it may only allow for a limited number of negotiating rounds established by an account holder using configurable tools displayed on the graphical user interface of the account holder computing device. In other embodiments, the system may not allow for any negotiating.

At block 2530, the system may receive from an account user a request to create or update a link parameter for an account associated with multiple account holders. As shown at block 2532, when the system determines that the account is associated with at least a second account holder, the system may require that all authorized account holders concur in any update to a link parameter requested by an account user. In such embodiments, creating or updating the transaction restriction parameter may include additional steps compared to when only one account holder is associated with the account. For example, in some embodiments, upon determining that the account is associated with a second account holder, the system may send to both the first and second account holders a request to approve the update request received from the account user. At block 2532, in embodiments requiring concurrence among account holders, the system may include the account holder-to-account holder negotiation and counter-proposal functionalities discussed above with respect to blocks 216 through 222 of FIG. 2.

Once the system has received any required concurrence among multiple account holders, at block cluster 2536 the system may proceed in the same manner described above with respect to blocks 2516 through 2528. At block cluster 2538, the system may satisfy the update request by accessing the server and storing in memory the requested new or updated link parameter. As represented by block cluster 2538, the system may then proceed to the point-of-sale process involving transaction approval and completion as described above with respect to blocks 224 through 246 of FIG. 2.

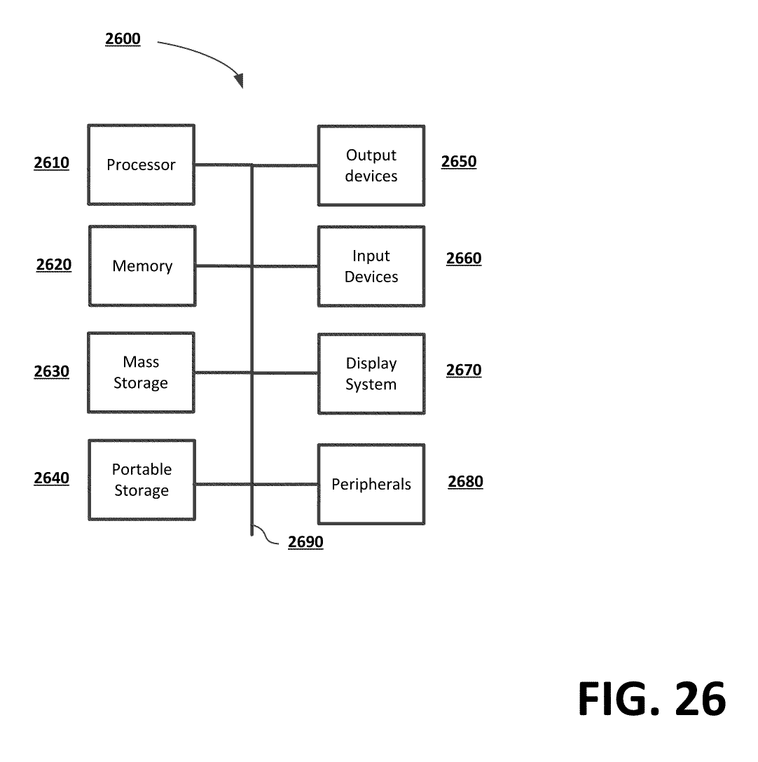

FIG. 26 is a block diagram of an exemplary computing device for implementing various embodiments of the systems and methods disclosed herein. Computing device 2600 of FIG. 26 may be implemented in the contexts of the likes of financial institution server 110, account holder computing device 130, account user computing device 170, payment service provider server 140, point of sale device 150, or database 160 of FIG. 1. Computing device 2600 of FIG. 26 may include one or more processors 2610 and memory 2620. Main memory 2620 may store, in part, instructions and data for execution by processor 2610. Main memory 2620 may store the executable code when in operation.

Computing device 2600 may further includes a mass storage device 2630, portable storage medium drive(s) 2640, output devices 2650, user input devices 2660, a graphics display 2670, and peripheral devices 2680.

The components shown in FIG. 26 are depicted as being connected via a single bus 2690. However, the components may be connected through one or more data transport means. For example, processor unit 2610 and main memory 2620 may be connected via a local microprocessor bus, and mass storage device 2630, peripheral device(s) 2680, portable storage device 2640, and display system 2670 may be connected via one or more input/output (I/O) buses.

Mass storage device 2630, which may be implemented with a magnetic disk drive or an optical disk drive, may be a non-volatile storage device for storing data and instructions for use by processor unit 2610. Mass storage device 2630 may be a non-transitory computer readable storage medium having embodied thereon a computer program or application. Mass storage device 2630 may store the system software for implementing embodiments of the systems and methods disclosed herein for purposes of loading that software into main memory 2620.

Portable storage device 2640 may operate in conjunction with a portable non-volatile storage medium, such as a floppy disk, compact disk or Digital video disc, to input and output data and code to and from computing device 2600. The system software for implementing embodiments of the systems and method disclosed herein may be stored on such a portable medium and input to computer device 2600 via the portable storage device 2640.

Input devices 2660 may provide a portion of a graphical user interface such as those described above. Input devices 2660 may include an alpha-numeric keypad, such as a keyboard, for inputting alpha-numeric and other information, a pointing device, such as a mouse, a trackball, stylus, or cursor direction keys, a touch pad, or any other suitable form of input device. Additionally, computing device 2600 may include output devices 2650. Examples of suitable output devices include, but are not limited to, speakers, printers, network interfaces, and monitors.

Display system 2670 may include a liquid crystal display (LCD) or other suitable display device. Display system 2670 may receive textual and graphical information, and processes the information for output to the display device.

Peripherals 2680 may include any type of computer support device to add additional functionality to the computing device. For example, peripheral device(s) 2680 may include a modem or a router.

The components contained in the computing device 2600 of FIG. 26 are those typically found in computer systems that may be suitable for use with embodiments of the systems and methods disclosed herein and are intended to represent a broad category of such computer components that are well-known in the art. Thus, computing device 2600 may be a personal computer, hand-held computing device, telephone, mobile computing device (e.g. a smartphone or tablet), workstation, server, minicomputer, mainframe computer, or any other computing device. The computer may also include different bus configurations, networked platforms, multi-processor platforms, etc. Various operating systems may be used including Unix, Linux, Windows, Macintosh OS, Palm OS, and other suitable operating systems.

In a further embodiment of the technology disclosed herein, a non-transitory computer-readable storage medium such as an optical disc, a memory card, or a computer disc is provided. The medium may have instructions, such as a computer program or application, embodied thereon. When executed by a processor of a computing device, the computing device may perform a method for controlling transactions executed by an account having multiple authorized account holders and/or linking multiple accounts as described above.

Referring back to FIG. 1, the functionality offered by an embodiment of the presently described systems and methods may be used without particular limitations as to hardware device (e.g., desktop versus laptop versus PDA), software, or means for connecting to network 120 of FIG. 1. For example, account holder computing device 170 (e.g., a smartphone) may connect to network 120 using a wireless connection and an 802.11x protocol. Account user computing device 130 may be a desktop computer connected to network 120 utilizing a cable modem and dial-up connection, respectively. Where account user computing device 130 and/or account holder computing device 170 are cellular devices, they may communicate over the network 120 using the General Packet Radio Service (GPRS) and available radio spectrum.

Network 120 may comprise various communications facilities and mediums (e.g., wireless, satellite, cable, optic, etc.) as may be provided by telecommunications companies and Internet Service Providers. Network 120 may be a geographically widespread network (e.g., a Wide Area Network) like the Internet that depends upon the aforementioned communications facilities to link various network segments. Network 120 may also be or be comprised of smaller linked communications networks such as Local Area Networks. A Local Area Network may be comprised of a group of computers and other devices dispersed over a relatively limited area and connected by, for example, a variety of broadband communications links. Local Area Networks may take on a variety of configurations including server-client, peer-to-peer, peer groups, or a combination of the same. Network 120 may also be a closed, proprietary network.

In some embodiments of the systems disclosed herein, the various computing devices may not be immediately connected to network 120. Rather, an intermediate computing device such as a centralized or enterprise server may intermediately couple one or more computing device to network 120. Various ancillary applications (e.g., enterprise applications or firewalls) may be implemented on the enterprise server or other intermediate computing device to allow for or enhance certain end-user functionality. Similarly, any variety of access points and routers may be implemented to provide communicative coupling with respect to network 120 and various devices communicating over the same.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for controlling transactions associated with an account having multiple authorized account holders, the method comprising:
receiving a request from a first account holder to access an account; and
executing instructions stored in memory, wherein execution of the instructions by a processor:
grants the first account holder access to the account;
receives from the first account holder a request to update a transaction restriction parameter stored in memory, wherein the transaction restriction parameter is associated with the account and restricts the ability of an account user to use the account for transactions; and
updates the transaction restriction parameter.

2. The method of claim 1, further comprising:
receiving from a server a transaction request, wherein the transaction request includes a plurality of transaction details; and
executing instructions stored in memory, wherein execution of the instructions by a processor:
compares the transaction details to the updated transaction restriction parameter, approves the transaction request when the transaction details do not violate the updated transaction restriction parameter, and
declines the transaction request when the transaction details violate the updated transaction restriction parameter.

3. The method of claim 2, wherein execution of the instructions by the processor further:
notifies the account holder that the transaction request was denied for violating the updated transaction restriction parameter; and
suggests to the account holder an update to the transaction restriction parameter that would permit approval of the transaction request.

4. The method of claim 1, wherein updating the transaction restriction parameter includes:
confirming that the account is not associated with a second account holder; and
updating the transaction restriction parameter based on the update request received from the first account holder.

5. The method of claim 1, wherein updating the transaction restriction parameter includes:
determining that the account is associated with a second account holder;
sending to the second account holder a request to approve the update request received from the first account holder;
receiving from the second account holder a response to the approval request; and
updating the transaction restriction parameter based on the update request received from the first account holder when the response to the approval request received from the second account holder is an approval.

6. The method of claim 1, wherein updating the transaction restriction parameter includes:
determining that the account is associated with a second account holder;
sending to the second account holder a request to approve the update request received from the first account holder;
receiving from the second account holder a response to the approval request, wherein the response to the approval request is a counter-proposed update;
sending to the first account holder a request to accept the counter-proposed update received from the second account holder;
receiving from the first account holder a response to the acceptance request;
updating the transaction restriction parameter based on the counter-proposed update received from the second account holder when the response received from the first account holder to the acceptance request is an acceptance.

7. The method of claim 1, wherein updating the transaction restriction parameter includes:
determining that the account is associated with a second account holder;
sending to the second account holder a request to approve the update request received from the first account holder;
receiving from the second account holder a response to the approval request, wherein the response to the approval request is a counter-proposed update;
sending to the first account holder a request to accept the counter-proposed update received from the second account holder;
receiving from the first account holder a response to the acceptance request, wherein the response to the acceptance response is a further counter-proposed update;
sending to the second account holder a request to accept the further counter-proposed update received from the first account holder;
receiving from the second account holder a response to the request to accept the further counter-proposed update;
updating the transaction restriction parameter based on the further counter-proposed update received from the first account holder when the response received from the second account holder to the request to accept the further counter-proposed is an acceptance.

8. A method for controlling transactions associated with an account having multiple authorized account holders, the method comprising:
receiving a request from a first account holder to access an account; and
executing instructions stored in memory, wherein execution of the instructions by a processor:
grants the first account holder access to the account;
receives from the first account holder a request to update a transaction restriction parameter stored in memory, wherein the transaction restriction parameter is associated with the account and restricts the ability of an account user to use the account for transactions;
determines that the account is associated with a second account holder;
sends to the second account holder a request to approve the update request received from the first account holder;
receives from the second account holder a response to the approval request; and
sends to the first account user a notification that the second account holder denied the approval request when the response to the approval request received from the second account holder is a denial; and
denies the update request received from the first account holder.

9. A transaction authorization control system, comprising:
a network; and
a server communicatively coupled by the network to a computing device associated with a first account holder, the server having a processor and executable instructions stored in memory, wherein execution of the instructions by the processor:
receives a request from a first account holder to access an account;
grants the first account holder access to the account;
receives from the first account holder a request to update a transaction restriction parameter stored in memory, wherein the transaction restriction parameter is associated with the account and restricts the ability of an account user to use the account for transactions; and
updates the transaction restriction parameter.

10. A method for linking multiple accounts, comprising:
receiving a request from a first account holder to access a first account; and
executing instructions stored in memory of a computing device, wherein execution of the instructions by a processor of the computing device:
grants the first account holder access to the first account;
receives from the first account holder a request to create an account link with a second account holder associated with a second account; and
creates an account link between the first account associated with the first account holder and the second account associated with the second account holder.

11. The method of claim 10, wherein receiving from the first account holder the request to create an account link with the second account holder associated with the second account further comprises receiving a request to store a link parameter in memory, the link parameter governing the manner in which funds are to be withdrawn from the first and second accounts in response to approving a transaction request.

12. The method of claim 11, wherein creating an account link between the first account associated with the first account holder and the second account associated with the second account holder further comprises storing the link parameter in memory.

13. The method of claim 12, wherein creating an account link between the first account associated with the first account holder and the second account associated with the second account holder further includes creating a third account associated with both the first account and the second account and governed by the link parameter.

14. The method of claim 12, wherein creating an account link between the first account associated with the first account holder and the second account associated with the second account holder further includes scheduling a one-time transfer between the first account and the second account based on the link parameter.

15. An account linking system, comprising:
a network;
a server communicatively coupled by the network to a computing device associated with a first account holder, the server having a processor and executable instructions stored in memory, wherein execution of the instructions by the processor:
receives a request from a first account holder to access a first account;
grants the first account holder access to the first account;
receives from the first account holder a request to create an account link with a second account holder associated with a second account; and
creates an account link between the first account associated with the first account holder and the second account associated with the second account holder.

16. The system of claim 15, wherein receiving from the first account holder the request to create an account link with the second account holder associated with the second account further comprises receiving a request to store a link parameter in memory, the link parameter governing the manner in which funds are to be withdrawn from the first and second accounts in response to approving a transaction request.

17. The system of claim 16, wherein creating an account link between the first account associated with the first account holder and the second account associated with the second account holder further comprises storing the link parameter in memory.

18. The system of claim 16, wherein creating an account link between the first account associated with the first account holder and the second account associated with the second account holder further includes creating a third account associated with both the first account and the second account and governed by the link parameter.

19. The system of claim 17, wherein creating an account link between the first account associated with the first account holder and the second account associated with the second account holder further includes scheduling a one-time transfer between the first account and the second account based on the link parameter.

20. The system of claim 15, wherein storing the link parameter in memory includes updating an existing link parameter.

21. The system of claim 15, wherein storing the link parameter in memory includes storing a new link parameter.
